(19) United States
(12) Patent Application Publication
(10) Pub. No.: US 2025/0289104 A1
(43) Pub. Date: Sep. 18, 2025

(54) LOW REACTION TORQUE DRIVER

(71) Applicant: NEWFREY LLC, New Britain, CT (US)

(72) Inventor: Zuher Naim Khalaf, Troy, MI (US)

(73) Assignee: NEWFREY LLC, New Britian, CT (US)

(21) Appl. No.: 19/057,385

(22) Filed: Feb. 19, 2025

Related U.S. Application Data
(60) Provisional application No. 63/564,705, filed on Mar. 13, 2024.

(51) Int. Cl. B25B 23/147; B25B 23/00; G05B 19/042

(52) U.S. Cl. CPC B25B 23/1475; G05B 19/042; B25B 23/0078; G05B 2219/21063

(57) ABSTRACT

An aspect of the present disclosure is drawn to a system for use with a torque tool and a fastening element. The torque tool has a motor and an engaging mechanism. The engaging mechanism can transfer a first torque to the fastening element when the motor operates in a first rotation mode and can transfer a second torque to the fastening element when the motor operates in a second rotation mode. The system includes a torque detector that detects a magnitude of torque applied to the fastening element and outputs a torque signal; and a controller that outputs a first drive signal to cause the motor to operate in the first rotation mode and outputs a second drive signal to cause the motor to operate in the second rotation mode based on the torque signal.

### CROSS-REFERENCE TO RELATED APPLICATIONS

The present application claims the benefit of priority to U.S. Provisional Patent Application No. 63/564,705 (filed on Mar. 13, 2024), which is hereby incorporated by reference in its complete entirety.

### TECHNICAL FIELD

One or more embodiments relate generally to hand-held torque tools that mitigate a reaction force experienced by the user's hand.

### BACKGROUND

Conventionally, a torque tool is a device used to apply a specific torque to a fastener, such as a nut, bolt, screw, or the like. Torque is a rotational force, and it is measured in units such as foot-pounds (ft-lbs) or newton-meters (Nm). Torque tools are important because they help to ensure that fasteners are tightened to the correct specification. This is important for safety and performance, as overtightening can damage fasteners and undertightening can lead to them loosening.

There are many different types of torque tools, but they all work on the same basic principle. They apply a force to a lever arm, or a rotational force to a rotating shaft, which causes a rotational force to be applied to the fastener.

In a conventional torque tool such as a drill driver, torque applied (e.g., to a fastener to be torqued) results from a reaction force experienced by the user's hand. That reaction force is related to discomfort the user might experience. This will be described in greater detail with reference to FIGS. 1-2D.

FIG. 1 illustrates a conventional torque tool 100.

As shown in the figure, torque tool 100 includes a main body 102, a handle 104, a trigger 105, a reaction bar 106, a motor controller 108 within main body 102, a power source 110 within main body 102, a motor 112 within main body 102, and an engaging mechanism 114, which includes portions within main body 102 and a fastening element engagement head 116 disposed outside main body 102.

Handle 104 enables a user to hold torque tool 100 with a hand.

Reaction bar 106 is operable to be held by the user's hand (not shown) that is not holding handle 104 or to rest against an immovable jig (not shown) to counter any counter-torque applied to torque tool 100 when in use. This will be described in greater detail below.

Motor controller 108 provides drive signals to motor 112 to control the rotational speed of the motor.

Power source 110 provides electricity to motor controller 108. Power source 110 may be any known power source, non-limiting examples of which include batteries and electrical power cords that are operable to plug into an electrical outlet.

Trigger 105 may be any device or system that is operable to connect/disconnect power source 110 from motor controller 108 so as to turn ON/turn OFF torque tool 100.

Motor 112 may be any type of electric motor that converts electricity to rotational movement.

Engaging mechanism 114 may be any known device or system that is able to transfer rotational movement generated by motor 112 to rotational movement to a fastening element (not shown). Engaging mechanism 114 may include components such as gears and rods.

Fastening element engagement head 116 may be part of engaging mechanism 114 or may be a distinct element that is operable to connect to engaging mechanism 114. Fastening element engagement head 116 is operable to engage with the fastening element so as to transfer rotational movement, and therefore torque, to the fastening element to either tighten or loosen the fastening element as needed.

FIG. 2A illustrates a rear view of torque tool 100 with a torque 202 applied to a fastening element (not shown). As shown in the figure, in operation, engaging mechanism 114 spins in a direction such that fastening element engagement head 116 applies torque 202 in a clockwise direction to the fastening element. In this example, the clockwise direction of torque 202 fastens the fastening element.

FIG. 2B illustrates a rear view of torque tool 100 with counter torque 204 applied to torque tool 100. As shown in the figure, and in accordance with Newton's third law of motion, the applied torque 202 in a clockwise direction to the fastening element results in an equal and opposite torque 204 in a counter-clockwise direction to torque tool 100.

FIG. 2C illustrates a rear view of torque tool 100 with a moment, or reaction force, 206 applied to handle 104 and a counter reaction force 208 applied by a hand of a user (not shown). As shown in the figure, the torque 204 in a counter-clockwise direction creates the reaction force 206 to handle 104 of torque tool 100. To prevent handle 104 from spinning in a counter clockwise direction as a result of reaction force 206, the hand of the user (not shown) must provide an equal and opposite reaction force 208 to handle 104. The required counter reaction force 208 is related to discomfort the user might experience. Particularly, if counter reaction force 208 remains continuously and/or is very large.

FIG. 2D illustrates a rear view of torque tool 100 with reaction force 206 applied to handle 104 and a counter reaction force 210 applied by reaction bar 106. As shown in the figure, the torque 204 in a counter-clockwise direction creates the reaction force 206 to handle 104 of torque tool 100. To prevent handle 104 from spinning in a counter clockwise direction as a result of reaction force 206, a user may apply an equal and opposite reaction force 210 to reaction bar 106. Again, the required counter reaction force 210 is related to discomfort the user might experience. Particularly, if counter reaction force 210 remains continuously and/or is very large. To alleviate the need of counter reaction force 210 to be provided by the user's hand, reaction bar 106 may be placed against an immovable object, such as a constructed jig. However, an immovable object may not be in the area for use and a jig may cost time and money to create.

What is needed is a hand-held torque tool that limits a reaction force experienced by the user's hand thereby relieving discomfort to the user over that of the conventional reaction bars discussed above, without the need of a reaction bar.

### SUMMARY

An aspect of the present disclosure is drawn to a reaction force mitigation (RFM) system for use with a torque tool and a fastening element. The torque tool has a motor and an engaging mechanism. The motor may be operable to operate in a first rotation mode so as to rotate the engaging mechanism at a first rate and to operate in a second rotation mode so as to rotate the engaging mechanism at a second rate. The engaging mechanism may be operable to transfer a first torque to the fastening element when the motor operates in the first rotation mode and to transfer a second torque to the fastening element when the motor operates in the second rotation mode. The RFM system includes: a torque detector operable to detect a magnitude of torque, T_{D}, applied to the fastening element and to output a torque signal based on T_{D}; and a controller operable to output a first drive signal to cause the motor to operate in the first rotation mode and to output a second drive signal to cause the motor to operate in the second rotation mode based on the torque signal.

In some embodiments of this aspect, the RFM system further includes: a memory having instructions and a threshold torque value, th_{T}, stored therein, wherein the controller includes a processor operable to execute instructions stored on the memory to cause the controller to: compare the magnitude of torque based on the torque signal to th_{T}; output the first drive signal when th_{T}>T_{D}; and output the second drive signal when th_{T}≤T_{D}. In some embodiments, th_{T} is less than 50 NM. In some embodiments, the processor is further operable to execute instructions stored on the memory to cause the controller to output the second drive signal a time period after a time when th_{T}≤T_{D}. In some embodiments, the processor is further operable to execute instructions stored on the memory to cause the controller to output the second drive signal a time period after a time when th_{T}≤T_{D}. In some embodiments, the motor has a plurality of phase windings, each of which provides a respective voltage phase, wherein the processor is further operable to execute instructions stored on the memory to cause the controller to: output the second drive signal so as to so as to disconnect the plurality of phase windings so as to output the zero drive current; and subsequently output a third drive signal so as to short the plurality of phase windings with one another. In some embodiments, the processor is further operable to execute instructions stored on the memory to cause the controller to: output the first drive signal as a drive current; and output the second drive signal as a zero drive current. In some embodiments, the processor is further operable to execute instructions stored on the memory to cause the controller to output the first drive signal a predetermined time period after outputting the second drive signal.

In other embodiments of this aspect, the torque detector includes a strain gauge transducer.

In other embodiments of this aspect, the RFM system further includes: a user interface operable to enable a user to set a threshold torque value, th_{T}; and a memory having instructions and th_{T}, stored therein, wherein the controller includes a processor operable to execute instructions stored on the memory to cause the controller to: compare the magnitude of torque based on the torque signal to th_{T}, output the first drive signal when th_{T}>T_{D}, and output the second drive signal when th_{T}≤T_{D}. In some embodiments, the user interface is further operable to enable the user to change the threshold torque value, th_{T}. In some embodiments, the motor has a plurality of phase windings, each of which provides a respective voltage phase, wherein the processor is further operable to execute instructions stored on the memory to cause the controller to: output the second drive signal so as to disconnect the plurality of phase windings so as to output the zero drive current; and subsequently output a third drive signal so as to short the plurality of phase windings with one another. In some embodiments, the processor is further operable to execute instructions stored on the memory to cause the controller to: cause the motor to output the first drive signal as a drive current; and cause the motor to output the second drive signal as a zero drive current. In some embodiments, the user interface is further operable to enable the user to change the threshold torque value, th_{T}. In some embodiments, the processor is further operable to execute instructions stored on the memory to cause the controller to output the first drive signal a predetermined time period after outputting the second drive signal.

In other embodiments of this aspect, the motor is additionally operable to operate in a third rotation mode so as to not rotate the engaging mechanism, the engaging mechanism may be operable to transfer a third torque to the fastening element when the motor operates in the third rotation mode, wherein the RFM system further includes: a memory having instructions, a threshold torque value, th_{T}, and a threshold average torque value, th_{TA}, stored therein, wherein controller includes a processor and is further operable to output a third drive signal to cause the motor to operate in the third rotation mode, and wherein the processor may be operable to execute instructions stored on the memory to cause the controller to: compare the magnitude of torque based on the torque signal to th_{T}, output the first drive signal when th_{T}>T_{D}; output the second drive signal when th_{T}≤T_{D}; output the third drive signal after outputting the second drive signal when th_{T}=T_{D}; calculate an average torque value, T_{AV}; and calculate a time, t, after outputting the third drive signal and based on T_{AV}, to output the first drive signal such that T_{AV}≤th_{TA}.

Another aspect of the present disclosure is drawn to a torque tool for use with a fastening element. The torque tool includes: a motor operable to operate in a first rotation mode and to operate in a second rotation mode; an engaging mechanism; a torque detector; and a controller. When operating in the first rotation mode, the motor may be operable to rotate the engaging mechanism at a first rate. When operating in the second rotation mode, the motor may be operable to rotate the engaging mechanism at a second rate. The engaging mechanism may be operable to transfer a first torque to the fastening element when the motor operates in the first rotation mode and to transfer a second torque to the fastening element when the motor operates in the second rotation mode. The torque detector may be operable to detect a magnitude of torque, T_{D}, applied to the fastening element and to output a torque signal based on T_{D}. The controller may be operable to output a first drive signal to cause the motor to operate in the first rotation mode and to output a second drive signal to cause the motor to operate in the second rotation mode based on the torque signal.

In some embodiments of this aspect, the controller includes: a memory having instructions and a threshold torque value, th_{T}, stored therein; and a processor operable to execute instructions stored on the memory to cause the controller to: compare the magnitude of torque based on the torque signal to th_{T}; output the first drive signal when th_{T}>T_{D}; and output the second drive signal when th_{T}≤T_{D}. In some embodiments, th_{T} is less than 50 NM. In some embodiments, the processor is further operable to execute instructions stored on the memory to cause the controller to output the second drive signal a time period after a time when th_{T}≤T_{D}. In some embodiments, the motor includes a plurality of phase windings, each of which provides a respective voltage phase, and the processor is further operable to execute instructions stored on the memory to cause the controller to: output the second drive signal so as to disconnect the plurality of phase windings so as to output the zero drive current; and subsequently output a third drive signal so as to short the plurality of phase windings with one another. In some embodiments the processor is further operable to execute instructions stored on the memory to cause the controller to: output the first drive signal as a drive current; and output the second drive signal as a zero drive current. In some embodiments, the processor is further operable to execute instructions stored on the memory to cause the controller to output the first drive signal a predetermined time period after outputting the second drive signal. In some embodiments of this aspect, the torque detector includes a strain gauge transducer.

In some embodiments of this aspect, the torque tool further includes: a user interface operable to enable a user to set a threshold torque value, th_{T}, wherein the controller includes: a memory having instructions and th_{T}, stored therein; and a processor operable to execute instructions stored on the memory to cause the controller to: compare the magnitude of torque based on the torque signal to th_{T}; output the first drive signal when th_{T}>T_{D}; and output the second drive signal when th_{T}≤T_{D}. In some embodiments, the user interface is further operable to enable the user to change the threshold torque value, th_{T}. In some embodiments, the processor is further operable to execute instructions stored on the memory to cause the controller to output the second drive signal a time period after a time when th_{T}≤T_{D}. In some embodiments, wherein the motor includes a plurality of phase windings, wherein each of which provides a respective voltage phase, the processor is further operable to execute instructions stored on the memory to cause the controller to: output the second drive signal so as to disconnect the plurality of phase windings so as to output the zero drive current; and subsequently output a third drive signal so as to short the plurality of phase windings with one another. In some embodiments, the processor is further operable to execute instructions stored on the memory to cause the controller to: output the first drive signal a drive current; and output the second drive signal as a zero drive current. In some embodiments, the user interface is further operable to enable the user to change the threshold torque value, th_{T}. In some embodiments, the processor is further operable to execute instructions stored on the memory to cause the controller to output the first drive signal a predetermined time period after outputting the second drive signal.

In some embodiments of this aspect, the motor is additionally operable to operate in a third rotation mode so as to not rotate the engaging mechanism, wherein the engaging mechanism may be operable to transfer a third torque to the fastening element when the motor operates in the third rotation mode. In these embodiments, the controller is further operable to output a third drive signal to cause the motor to operate in the third rotation mode, and the controller includes: a memory having instructions, a threshold torque value, th_{T}, and a threshold average torque value, th_{TA}, stored therein; and a processor operable to execute instructions stored on the memory to cause the controller to: compare the magnitude of torque based on the torque signal to th_{T}; output the first drive signal when th_{T}>T_{D}; output the second drive signal when th_{T}≤T_{D}; output the third drive signal after outputting the second drive signal when th_{T}=T_{D}; calculate an average torque value, T_{AV}; and calculate a time, t, after outputting the third drive signal and based on T_{AV}, to output the first drive signal such that T_{AV}≤th_{TA}.

Another aspect of the present disclosure is drawn to a computer-implemented method of operating a torque tool for use with a fastening element. The torque tool includes a motor operable to operate in a first rotation mode and to operate in a second rotation mode, an engaging mechanism, a torque detector, and a controller. The computer-implemented method includes: operating the motor in the first rotation mode to rotate the engaging mechanism at a first rate such that the engaging mechanism transfers a first torque to the fastening element; operating the motor in the second rotation mode to rotate the engaging mechanism at a second rate such that the engaging mechanism transfers a second torque to the fastening element; detecting, via the torque detector, a magnitude of torque, T_{D}, applied to the fastening element; outputting, via the torque detector, a torque signal based on T_{D}; outputting, via the controller, a first drive signal to cause the motor to operate in the first rotation mode; and outputting, via the controller, a second drive signal to cause the motor to operate in the second rotation mode based on the torque signal.

In some embodiments of this aspect, the computer-implemented method further includes: comparing, via the controller including a memory having instructions and a threshold torque value, th_{T}, stored therein, and a processor operable to execute instructions stored on the memory, the magnitude of torque based on the torque signal to thT; outputting, via the processor, the first drive signal when thT≥T_{D}; and outputting, via the processor, the second drive signal when thT≤T_{D}. In some embodiments, thT is less than 50 NM. In some embodiments, wherein the outputting of the second drive signal includes outputting the second drive signal a time period after a time when thT≤T_{D}. In some embodiments, wherein the outputting of the second drive signal includes outputting the second drive signal a time period after a time when thT≤T_{D}. In some embodiments, wherein the motor has a plurality of phase windings, each of which provides a respective voltage phase, further including: outputting a third drive signal, wherein outputting, via the processor, the second drive signal as the zero drive current comprises outputting the second drive signal so as to disconnect the plurality of phase windings so as to output the zero drive current, and wherein outputting the third drive signal comprises subsequently outputting the third drive signal so as to short the plurality of phase windings with one another. In some embodiments, the computer-implemented method further includes: outputting, via the processor, the first drive signal as drive current; and outputting, via the processor, the second drive signal as a zero drive current. In some embodiments, the computer-implemented method further includes outputting, via the controller, the first drive signal a predetermined time period after outputting the second drive signal.

In some embodiments of this aspect, the detecting, via the torque detector, a magnitude of torque, T_{D}, applied to the fastening element includes detecting via a strain gauge transducer.

In some embodiments of this aspect, the computer-implemented method further includes: enabling, via a user interface, a user to set a threshold torque value, th_{T}; comparing, via the processor, the magnitude of torque based on the torque signal to th_{T} additionally being stored in the memory; outputting, via the processor, the first drive signal when th_{T}>T_{D}; and outputting, via the processor, the second drive signal when th_{T}≤T_{D}. In some embodiments, the computer-implemented method further includes enabling, via the user interface, the user to change the threshold torque value, th_{T}. In some embodiments, wherein the motor having a plurality of phase windings, each of which provides a respective voltage phase, further including: outputting a third drive signal, wherein outputting, via the processor, the second drive signal as the zero drive current comprises outputting the second drive signal so as to disconnect the plurality of phase windings so as to output the zero drive current, and wherein outputting the third drive signal comprises subsequently outputting the third drive signal so as to short the plurality of phase windings with one another. In some embodiments, the computer-implemented method further includes: outputting, via the controller, the first drive signal as a drive current; and outputting, via the controller, the second drive signal as a zero drive current. In some embodiments of this aspect, the computer-implemented method further includes enabling, via the user interface, the user to change the threshold torque value, th_{T}. In some embodiments, the computer-implemented method further includes outputting, via the controller, the first drive signal a predetermined time period after outputting the second drive signal.

In some embodiments of this aspect, the motor is operable to additionally operate in a third rotation mode so as to not rotate the engaging mechanism, the engaging mechanism is operable to transfer a third torque to the fastening element when the motor operates in the third rotation mode, and the torque tool further includes a memory having instructions, a threshold torque value, th_{T}, and a threshold average torque value, th_{TA}, stored therein, wherein computer-implemented method further includes: operating the motor in the third rotation mode so as not to rotate the engaging mechanism at a first rate such that the engaging mechanism transfers a third torque to the fastening element; comparing, via the controller including a processor operable to execute instructions stored on the memory, the magnitude of torque based on the torque signal to th_{T}; outputting, via the controller, the first drive signal when th_{T}>T_{D}; outputting, via the controller, the second drive signal when th_{T}≤T_{D}; outputting, via the controller, the third drive signal after outputting the second drive signal when th_{T}=T_{D}; calculating, via the controller, an average torque value, T_{AV}; and calculating, via the controller, a time, t, after outputting the third drive signal and based on T_{AV}, to output the first drive signal such that T_{AV}≤th_{TA}.

### DRAWINGS

The accompanying drawings, which are incorporated in and form a part of the specification, illustrate and explain example embodiments. In the drawings:

FIG. 1 illustrates a conventional torque tool;

FIG. 2A illustrates a rear view of the torque tool of FIG. 1 with torque applied to a fastening element (not shown);

FIG. 2B illustrates a rear view of the torque tool of FIG. 1 with counter torque applied to the torque tool;

FIG. 2C illustrates a rear view of the torque tool of FIG. 1 with a reaction force applied to the handle and a counter reaction force applied by a hand of a user;

FIG. 2D illustrates a rear view of the torque tool of FIG. 1 with a reaction force applied to the handle and a counter reaction force applied by a reaction bar;

FIG. 3 illustrates a torque tool in accordance with aspects of the present disclosure;

FIG. 4A illustrates a rear view of the torque tool of FIG. 3 with torque applied to a fastening element (not shown);

FIG. 4B illustrates a rear view of the torque tool of FIG. 3 with counter torque applied to the torque tool;

FIG. 4C illustrates a rear view of the torque tool of FIG. 3 with a reaction force applied to the handle and a counter reaction force applied by a hand of a user;

FIG. 4D illustrates a rear view of the torque tool of FIG. 1 with no torque applied to the fastening element;

FIG. 5 illustrates a graph of torque as a function of time of a torque tool in operation in accordance with aspects of the present disclosure;

FIG. 6 illustrates a graph of torque as a function of time and rotations per minute (RPM) of a motor of a torque tool in operation in accordance with aspects of the present disclosure;

FIG. 7 illustrates a blown up portion of the graph of FIG. 6;

FIG. 8A illustrates a first portion of a computer-implemented method of operating a torque tool in accordance with aspects of the present disclosure;

FIG. 8B illustrates a second portion of the computer-implemented method of FIG. 8A;

FIG. 8C illustrates a third portion of the computer-implemented method of FIG. 8A;

FIG. 9A illustrates a block diagram of a torque tool with a fastening element in accordance with aspects of the present disclosure;

FIG. 10A illustrates a block diagram of a reaction force mitigation (RFM) system during an initial operation state in accordance with aspects of the present disclosure;

FIG. 10B illustrates a block diagram of the RFM system of FIG. 10A during a parameter detecting state in accordance with aspects of the present disclosure;

FIG. 10C illustrates a block diagram of the RFM system of FIG. 10A during a torque threshold state in accordance with aspects of the present disclosure;

FIG. 10D illustrates a block diagram of the RFM system of FIG. 10A during a zero-RPM threshold state in accordance with aspects of the present disclosure;

FIG. 10E illustrates a block diagram of the RFM system of FIG. 10A in a third operation state in accordance with aspects of the present disclosure;

FIG. 11 illustrates another computer-implemented method of operating a torque tool in accordance with aspects of the present disclosure;

FIG. 12 illustrates a block diagram of another RFM system during an initial operation state in accordance with aspects of the present disclosure;

FIG. 13A illustrates a graph of a speed command provided to a motor and actual speed of motor;

FIG. 13B illustrates a graph of the actual speed of the motor and torque;

FIG. 13C illustrates a graph of the actual speed of a motor and current;

FIG. 13D illustrates a graph of torque and current;

FIG. 14 illustrates a graph of actual speed of a motor and torque:

FIG. 15A represents a circuit diagram of a motor within a torque tool in accordance with aspects of the present disclosure at a time t₀;

FIG. 15B represents circuit diagram of FIG. 15A at a time t₁; and

FIG. 15C represents circuit diagram of FIG. 15A at a time t₂.

### DESCRIPTION

A torque tool in accordance with aspects of the present disclosure limits a reaction force experienced by the user's hand thereby relieving discomfort to the user over that of the conventional reaction bars discussed above, without the need of a reaction bar.

In accordance with aspects of the present disclosure, a torque tool applies torque to a fastening element in discrete pulses, wherein the pulse width limits the applied torque during any pulse by a predetermined torque threshold. Further, after a small magnitude of torque is applied during a single pulse, the torque tool applies no torque for a calculated period of time. The calculated period of time is determined to keep the average magnitude of torque applied during one cycle below an average torque threshold, which is set to be sufficiently low so as to decrease discomfort to the user, as compared to conventional torque tools. In this manner, because the torque is applied in discrete pulses separated by periods of zero applied torque, a user of the torque tool does not experience a continuous reaction force for the entire time that the torque tool fastens a fastening element. Further, because the average torque threshold is set to be sufficiently low so as to decrease discomfort to the user, as compared to conventional torque tools, the user experiences overall less discomfort as compared to conventional torque tools.

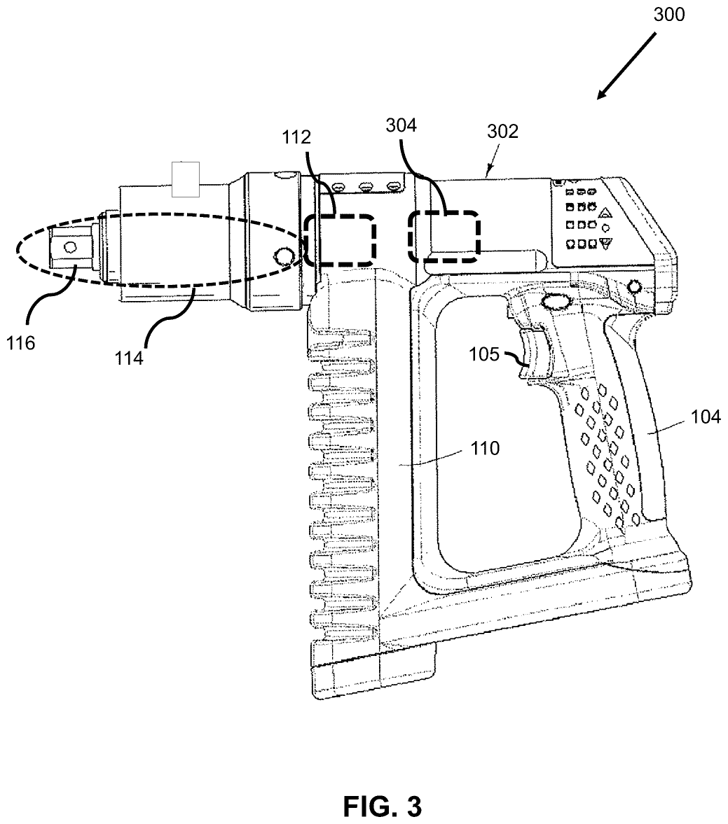

Aspects of a torque tool in accordance with the present disclosure will now be described in greater detail with reference to FIGS. 3-10E.

FIG. 3 illustrates a torque tool 300 in accordance with aspects of the present disclosure.

As shown in the figure, torque tool 300 includes a main body 302, handle 104, trigger 105, a reaction force mitigation (RFM) system 304 within main body 302, power source 110 within main body 302, motor 112 within main body 302, and engaging mechanism 114, which includes portions within main body 302 and fastening element engagement head 116 disposed outside main body 302.

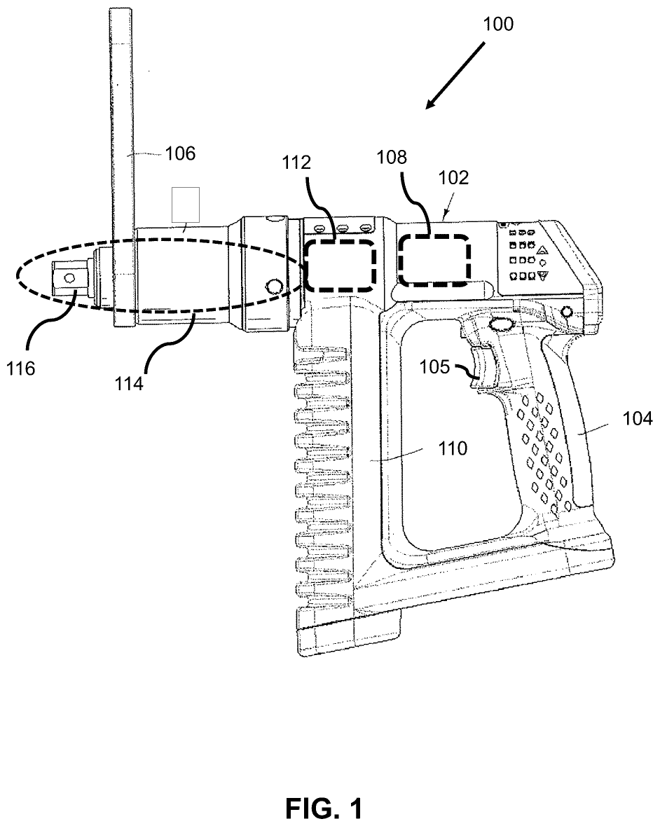

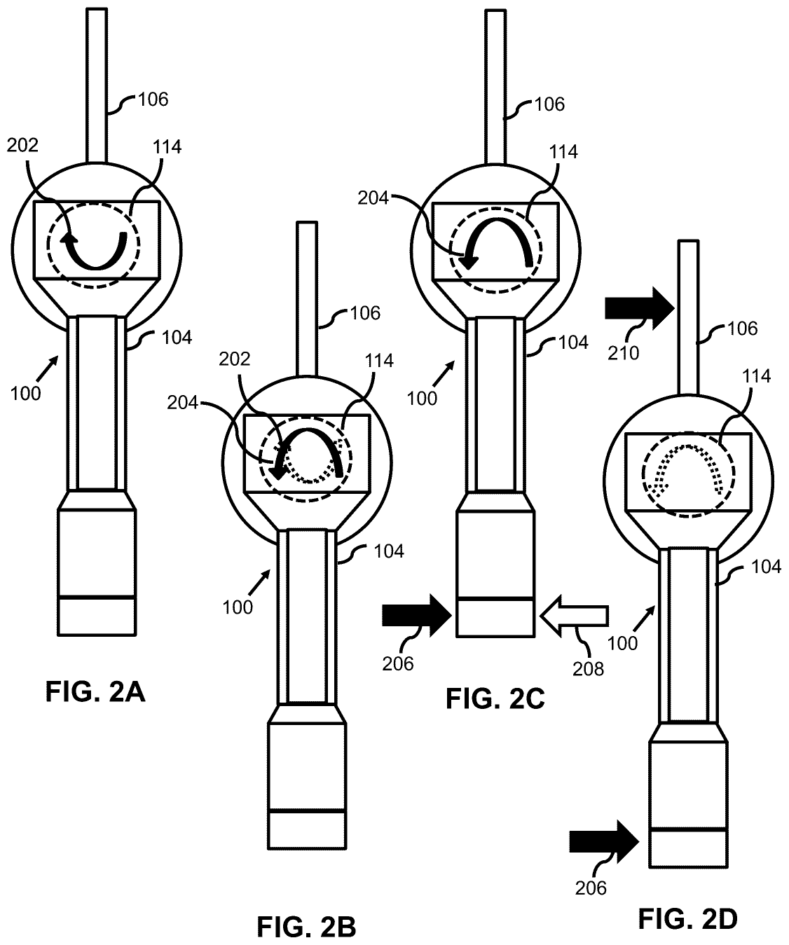

Torque tool 300 differs from torque tool 100 discussed above with reference to FIGS. 1-2 in that torque tool 300 replaces main body 102 of torque tool 100, replaces motor controller 108 with RFM system 304, and does not include reaction bar 106.

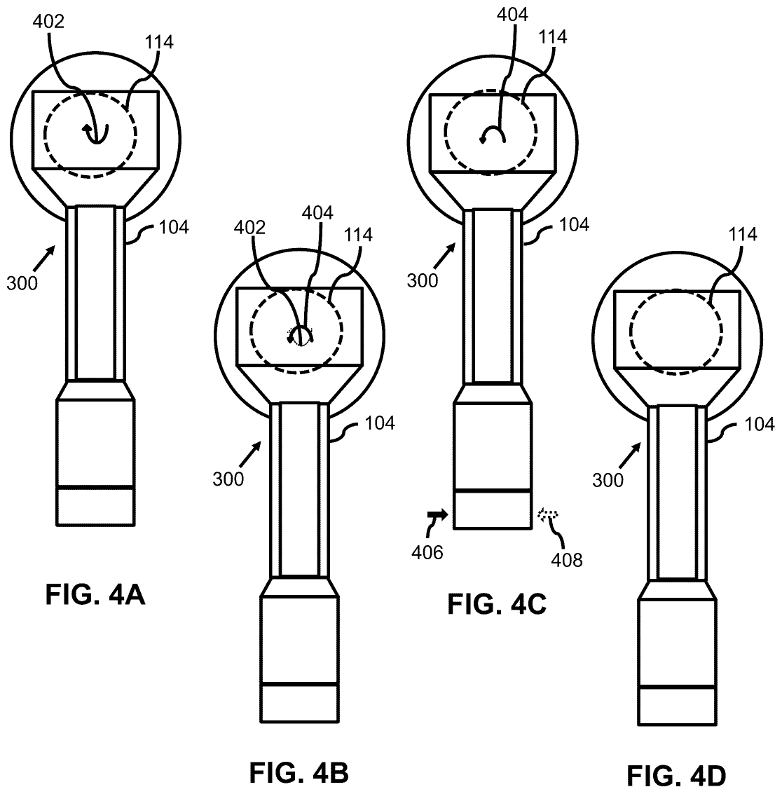

FIG. 4A illustrates a rear view of torque tool 300 with torque 402 applied to a fastening element (not shown). As shown in the figure, in operation, engaging mechanism 114 spins in a direction such that fastening element engagement head 116 applies torque 402 in a clockwise direction to the fastening element.

FIG. 4B illustrates a rear view of torque tool 300 with counter torque 404 applied to torque tool 300. As shown in the figure, an in accordance with Newton's third law of motion, the applied torque 402 in a clockwise direction to the fastening element results in an equal and opposite torque 404 in a counter-clockwise direction to torque tool 300.

FIG. 4C illustrates a rear view of torque tool 300 with a reaction force 406 applied to handle 104 and a counter reaction force 408 applied by a hand of a user (not shown). As shown in the figure, the torque 404 in a counter-clockwise direction creates the reaction force 406 to handle 104 of torque tool 300. To prevent handle 104 from spinning in a counter clockwise direction as a result of reaction force 406, the hand of the user (not shown) must provide an equal and opposite counter reaction force 408 to handle 104. It should be noted that counter reaction force 408 is much smaller than counter reaction force 208 discussed above with reference to 100 of FIG. 2C. This is represented by the smaller arrow representing counter reaction force 408 as compared to the much larger arrow representing counter reaction force 208 of FIG. 2C.

FIG. 4D illustrates a rear view of torque tool 300 with no torque applied to the fastening element (not shown). As shown in the figure, as a result of no torque being applied to the fastening element, there is not resulting counter torque, which means there is no reaction force applied to handle 104, and which means that the hand of the user (not shown) does not need to provide any counter reaction force to handle 104 at this time. It should be noted that the lack of constant counter reaction force in accordance with aspects of the present disclosure reduces the overall counter reaction force that must be applied by a user of torque tool 100 as discussed above with reference to FIGS. 1-2D.

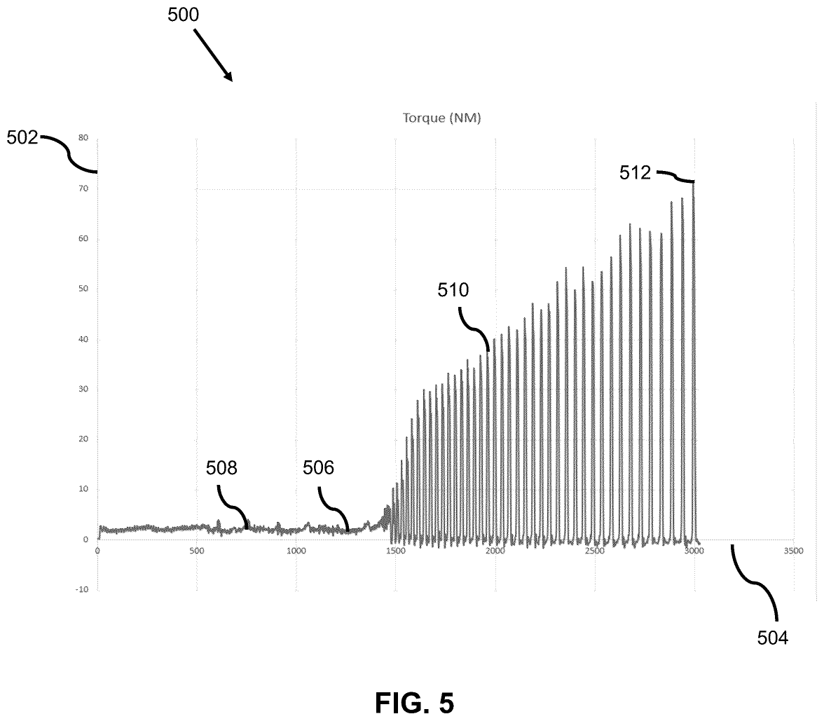

FIG. 5 illustrates a graph 500 of torque as a function of time of a torque tool in operation in accordance with aspects of the present disclosure.

As shown in the figure, graph 500 includes a y-axis 502, an x-axis 504 and a function 506. Y-axis is torque and is measured in units of Newton-Meters. X-axis 504 is time and is measured in units of milliseconds. Function 506, includes a buildup portion 508 and a torque applying portion 510, which includes a plurality of pulses, an indication of which is labeled as pulse 510. Function 506 includes pulse 512 corresponding to a maximum intended applied torque, which in this example is 72 NM.

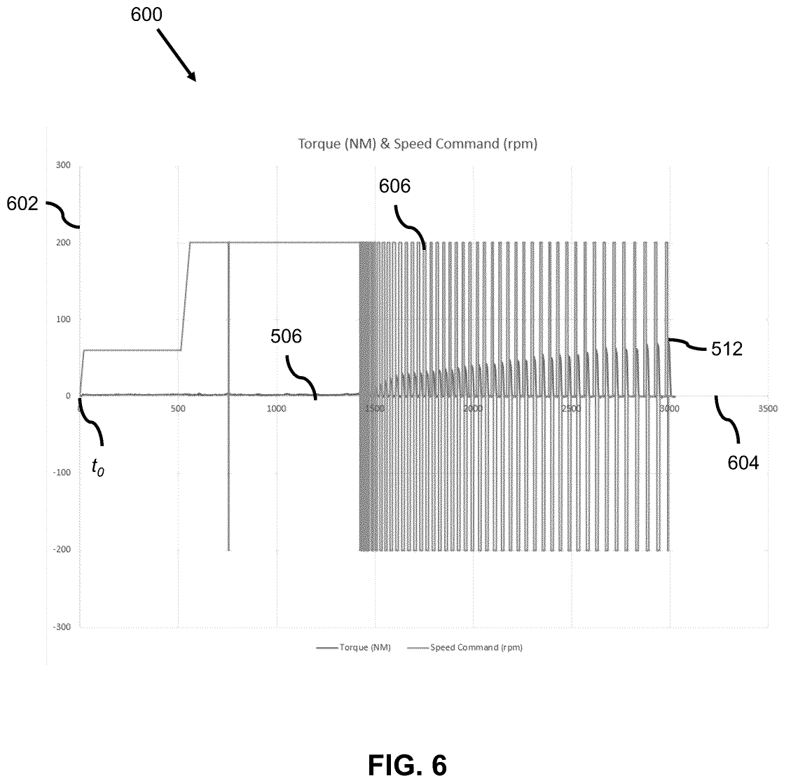

FIG. 6 illustrates a graph 600 of torque as a function of time and rotations per minute (RPM) of a motor of a torque tool in operation in accordance with aspects of the present disclosure.

As shown in the figure, graph 600 includes a y-axis 602, an x-axis 604, function 506, and a function 606. Y-axis is the rotating speed of the motor and is measured in units of rotations per minute (RPMs). X-axis 604 is time and is measured in units of milliseconds. Function 606 corresponds to the RPMs of the motor as a function of time and includes a plurality of positive and negative pulses.

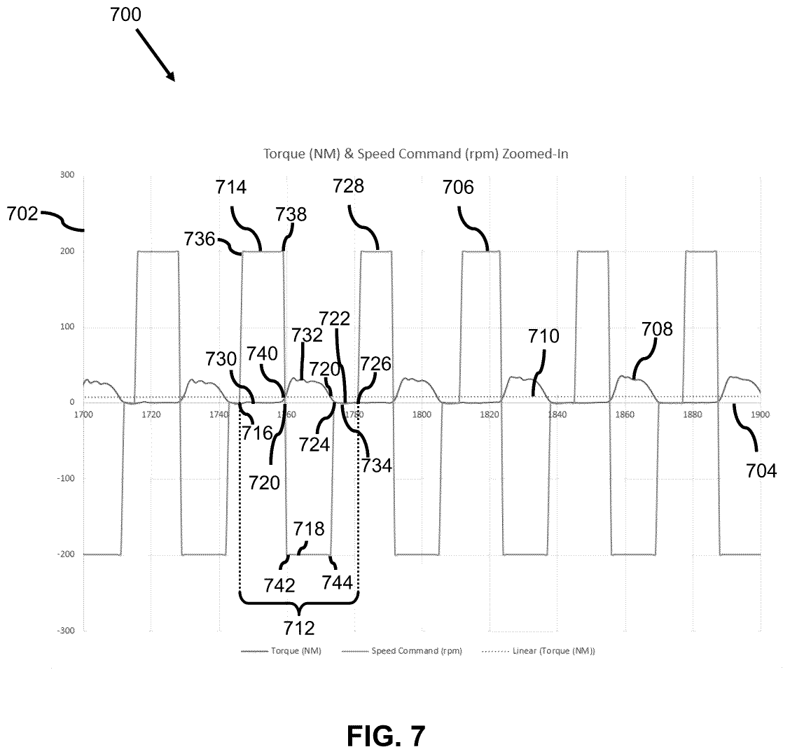

FIG. 7 illustrates a blown up portion 700 of graph 600.

As shown in the figure, graph 700 includes a y-axis 702, an x-axis 704, a function 706, and a function 708. Y-axis is the rotating speed of the motor and is measured in units of rotations per minute (RPMs). X-axis 704 is time and is measured in units of milliseconds. Function 706 corresponds to the speed command of the motor and is measures in RPMs. Function 708 corresponds to the torque applied to a fastening element by the torque tool and is measured in NM. Function 710 corresponds to a predetermined threshold torque and is measured in NM.

Function 706 includes a plurality of RPM cycles, each having a respective period, an example of which includes a cycle 712, which runs: from the beginning of a positive-RPM-period pulse 714 starting at a time 716; through a negative-RPM-period pulse 718 starting at a time 720; and through a zero-RPM time period 722 starting at a time 724 and ending at a time 726. The next period initiates with a new positive-RPM-period pulse 728 that starts at time 726.

Function 708 includes a plurality of torque cycles, each having a respective period that matches a respective RPM cycle. For example, period in cycle 712 runs: from the beginning of a non-negative-torque time period 730 starting at time 716; through a positive-torque time period 732; and through a following non-negative-torque time period time 734 ending at time 726. The next period initiates with a new non-negative-torque time period that starts at time 726.

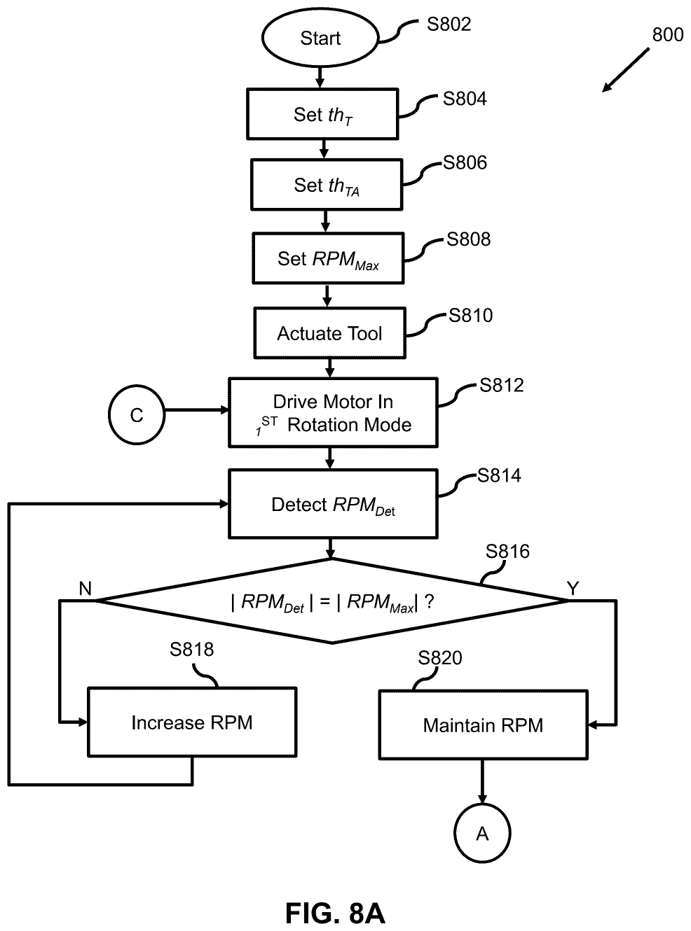

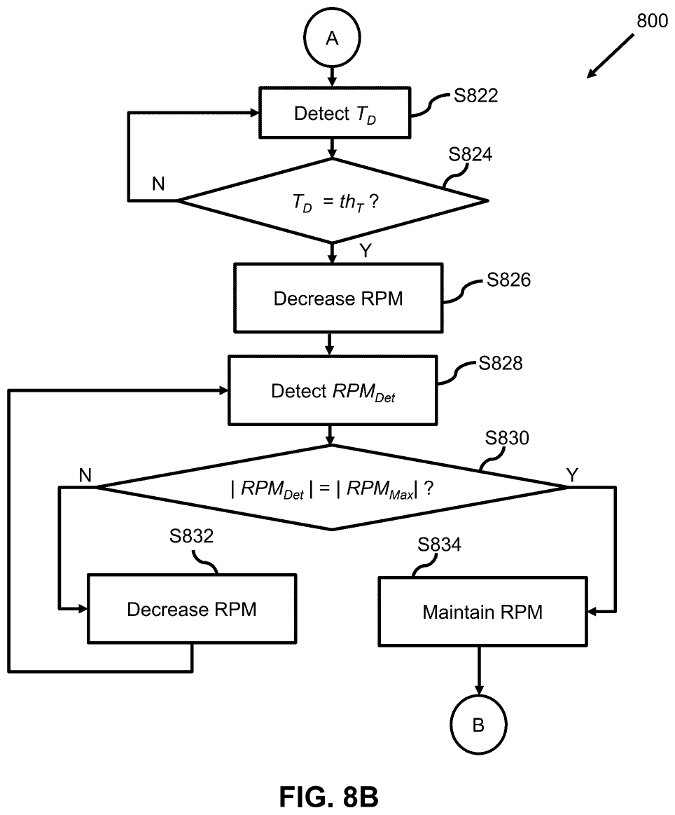

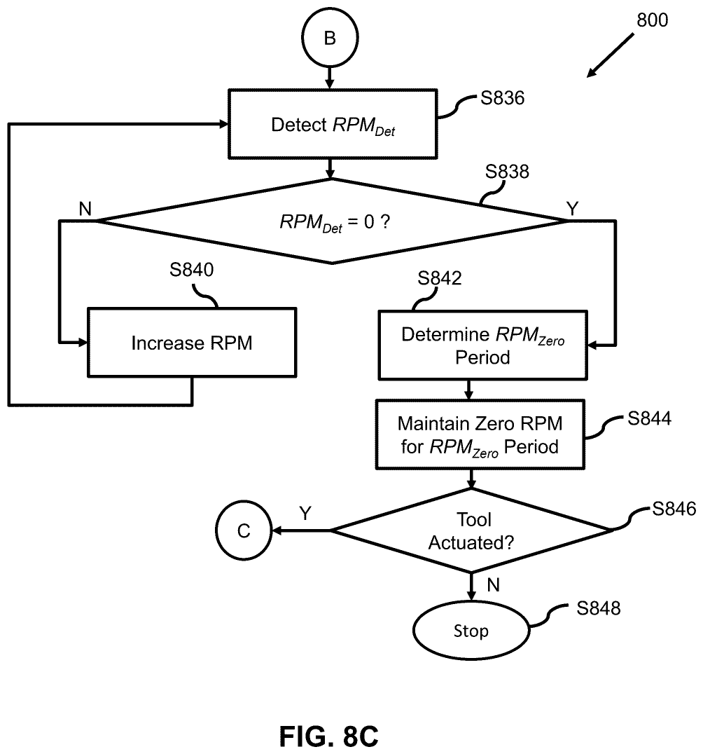

The interplay of the motor speed of a torque tool in accordance with aspects of the present disclosure as represented by function 706, the torque applied to a fastening element by the torque tool as represented by function 708 and the predetermined threshold torque as represented by function 710 will now be described in greater detail with additional reference to FIGS. 8A-10E.

FIGS. 8A-C illustrates a computer-implemented method 800 of operating a torque tool in accordance with aspects of the present disclosure, wherein FIG. 8A illustrates a first portion of computer-implemented method 800, FIG. 8B illustrates a second portion of computer-implemented method 800, and FIG. 8C illustrates a final portion of computer-implemented method 800.

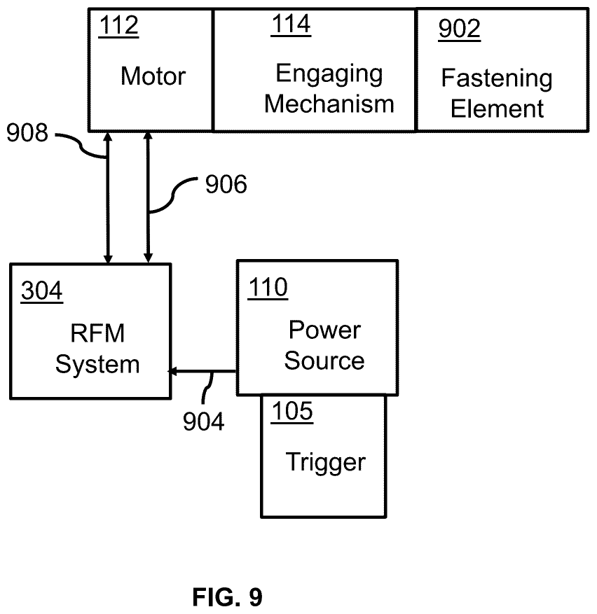

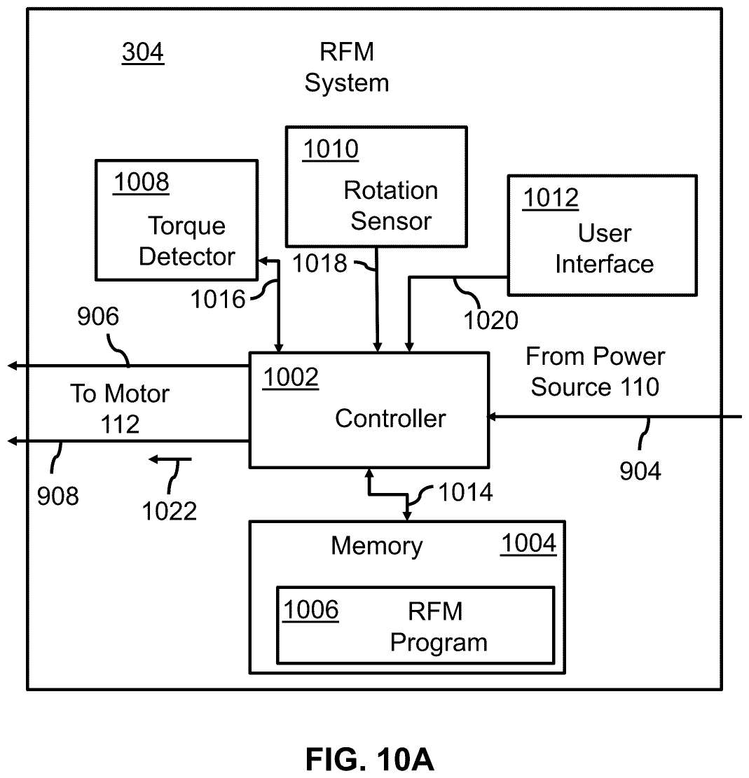

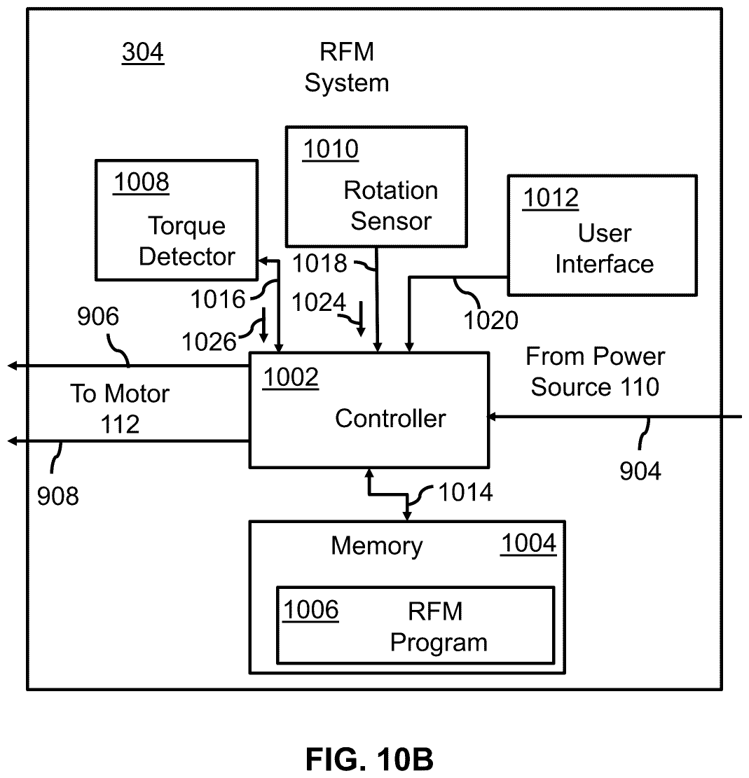

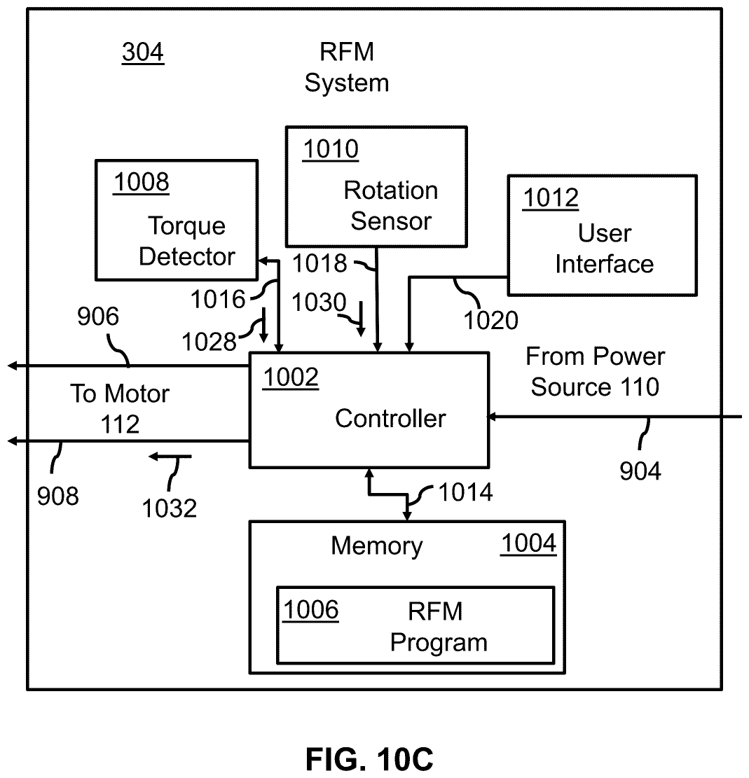

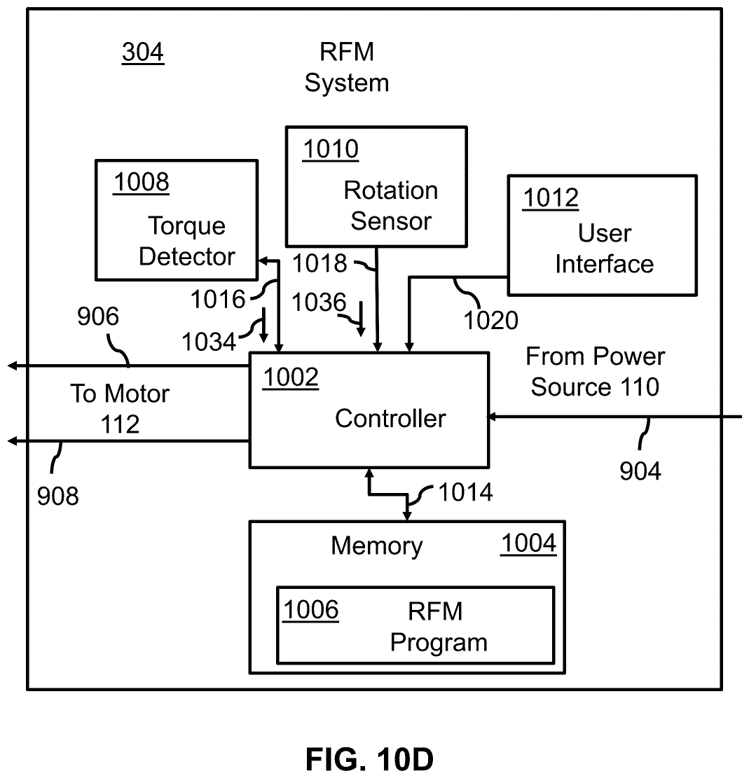

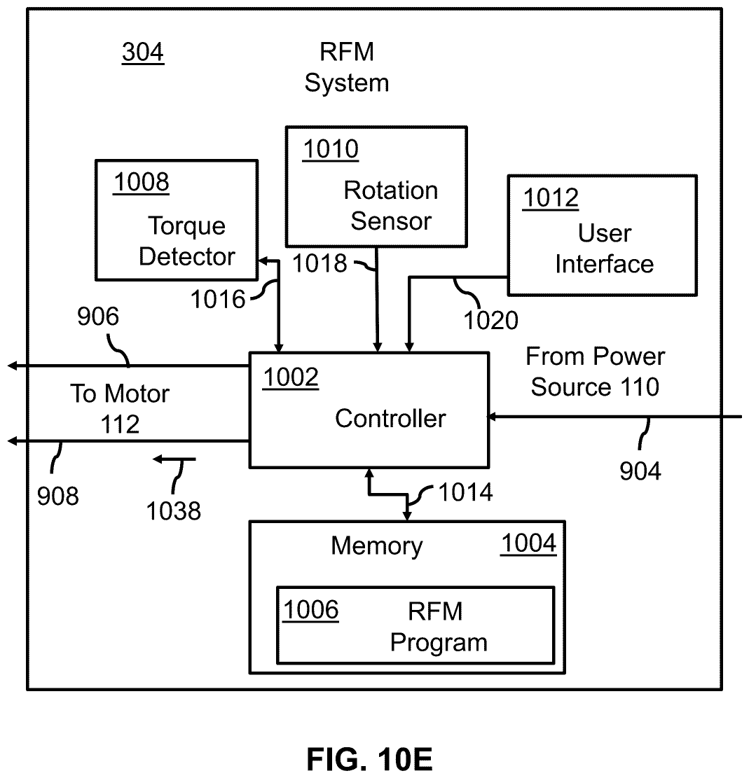

As shown in FIG. 8A, computer-implemented method 800 starts (S802) and a threshold torque, th_{T}, is set (S804). This will be described in greater detail with reference to FIGS. 9 and 10A.

FIG. 9 illustrates a block diagram of torque tool 302 with a fastening element 902 in accordance with aspects of the present disclosure.

As shown in the figure, torque tool 302 includes trigger 105, power source 110, motor 112, engaging mechanism 114, and RFM system 304.

Power source 110 may be operable to provide power to RFM system 304 via a power line 904. RFM system 304 is additionally operable to provide power to motor 112 via a power line 906 and to communicate with motor 112 via a communication channel 908. Motor 112 is additionally operable to engage with engaging mechanism 114. Engaging mechanism 114 may be operable to engage with fastening element 902.

Trigger 105 may be any device or system that is operable to connect/disconnect power source 110 from RFM system 304 so as to turn ON/turn OFF torque tool 302.

Power lines 904 and 906 may each be any known electricity conducting line, a non-limiting example of which includes a copper wire.

Communication channel 908 may be any known type of communication channel, non-limiting examples of which include a wired communication channel or wireless communication channel.

In operation, a threshold torque, th_{T}, is set by RFM system 304. This will be described in greater detail with reference to FIG. 10A.

FIG. 10A illustrates a block diagram of RFM system 304 during an initial operation state in accordance with aspects of the present disclosure.

As shown in the figure, RFM system 304 includes a controller 1002, a memory 1004 having RFM program 1006 stored therein, a torque detector 1008, a rotation sensor 1010, and a user interface (UI) 1012.

Controller 1002 may be configured: to receive power from power source 110 via power line 904; to communicate with memory 1004 via a communication channel 1014; to provide power to motor 112 via power line 906; to communicate with motor 112 via communication channel 908; to communicate with torque detector 1016 via a communication channel 1016; to communicate with rotation sensor 1010 via a communication channel 1018; and to communicate with UI 1012 via a communication channel 1020.

In this example, controller 1002, memory 1004, torque detector 1008, rotation sensor 1010, and UI 1012 are illustrated as individual devices. However, in some embodiments, at least two of controller 1002, memory 1004, torque detector 1008, rotation sensor 1010, and UI 1012 may be combined as a unitary device. Further, in some embodiments, at least one of controller 1002, memory 1004, torque detector 1008, rotation sensor 1010, and UI 1012 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-executable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large-scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or computer-implemented methodologies of various embodiments of the application as described herein.

Controller 1002 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of RFM system 304 in accordance with the embodiments described in the present disclosure.

Memory 1004, as will be described in greater detail below, has instructions, including RFM program 1006, stored therein to be executed by controller 1002 causing RFM system 304 to: operate motor 112 in a first rotation mode; operate motor 112 in a second rotation mode; output a first drive signal to cause motor 112 to operate in the first rotation mode to rotate engaging mechanism 114 at a first rate such that engaging mechanism 114 transfers a first torque to fastening element 902; and output a second drive signal to cause motor 112 to operate in the second rotation mode, based a detected torque value, T_{D}, that is based on a torque signal from torque detector 1008, to rotate engaging mechanism 114 at a second rate such that engaging mechanism 114 transfers a second torque to fastening element 902.

In some embodiments, memory 1004, as will be described in greater detail below, has a torque threshold th_{T} and additional instructions stored therein, wherein the instructions are to be executed by controller 1002 causing RFM system 304 to further: compare the magnitude of torque based on the torque signal to th_{T}; output the first drive signal when th_{T}>T_{D}; and output the second drive signal when th_{T}≤T_{D}. In some embodiments, th_{T} is less than 50 NM.

In some embodiments, memory 1004, as will be described in greater detail below, has a torque threshold th_{T} and additional instructions stored therein, wherein the instructions are to be executed by controller 1002 causing RFM system 304 to further: enable, via UI 1012, a user to set a threshold torque value, th_{T}; compare the magnitude of torque based on the torque signal to th_{T}; output the first drive signal when th_{T}>T_{D}; and output the second drive signal when th_{T}≤T_{D}. In some embodiments, memory 1004, as will be described in greater detail below, has additional instructions stored therein, wherein the instructions are to be executed by controller 1002 causing RFM system 304 to further: enable, via UI 1012, the user to change the threshold torque value, th_{T}.

Torque detector 1008 may be any known device or system that is operable to detect a magnitude of torque, T_{D}, applied to the fastening element and to output a torque signal based on T_{D}. In some embodiments, torque detector 1008 may be a strain gauge transducer.

Rotation sensor 1010 may be any known device or system that is operable to detect the rotations per minute (RPMs) of motor 112 and output an RPM signal based on the detected RPMs. In some embodiments, rotation sensor 1010 may be an optical RPM sensor or a magnetic RPM sensor.

UI 1012 may be any known device or system that is operable to enable a user to access and control controller 1002. UI 1012 may include one or more layers including a human-machine interface (HMI) machines with physical input hardware such a keyboards, mice, game pads and output hardware such as computer monitors, speakers, and printers. Additional UI layers in UI 1012 may interact with one or more human senses, including: tactile UI (touch), visual UI (sight), and auditory UI (sound).

Communication channels 1014, 1016, 1018, and 1020 may be any known type of communication channel, non-limiting examples of which include wired communication channels or wireless communication channels.

In operation, the value of th_{T} is set in memory 1004.

For example, in some embodiments, memory 1004 may have the value of th_{T} stored therein as a priori data. In this manner, the value of th_{T} may be set.

In some embodiments, a user may interact with UI 1012 to input the value of th_{T} into memory 1004. For example, UI 1012 may be operable to provide the value of th_{T} as input by the user to controller 1002 via communication channel 1020. Controller 1002 may be operable to execute instructions in RFM program 1006 to, upon receiving the value of th_{T} from UI 1012, to store the value of th_{T} into memory 1004 via communication channel 1014. In this manner, the value of th_{T} may be set.

In some embodiments, a user may interact with UI 1012 to change a value of th_{T} that is currently stored in memory 1004. For example, UI 1012 may be operable to provide a new value of th_{T} as input by the user to controller 1002 via communication channel 1020. Controller 1002 may be operable to execute instructions in RFM program 1006 to, upon receiving the new value of th_{T} from UI 1012, to overwrite a currently stored value of th_{T} in memory 1004 with the new value of th_{T} into memory 1004 via communication channel 1014. In this manner, the value of th_{T} may be set.

Returning to FIG. 7, in this example, the value of th_{T} is set at 7 NM as represented by function 710.

Returning to FIG. 8A, after the value of th_{T} is set (S804), a threshold average torque value, th_{TA}, is set (S806). For example, as shown in FIG. 9, a threshold average torque value, th_{TA}, is set by RFM system 304. This will be described in greater detail with reference to FIG. 10A.

As shown in FIG. 10A, in operation, the value of th_{TA} is set in memory 1004.

For example, in some embodiments, memory 1004 may have the value of th_{TA} stored therein as a priori data. In this manner, the value of th_{TA} may be set.

In some embodiments, a user may interact with UI 1012 to input the value of th_{TA} into memory 1004. For example, UI 1012 may be operable to provide the value of th_{TA} as input by the user to controller 1002 via communication channel 1020. Controller 1002 may be operable to execute instructions in RFM program 1006 to, upon receiving the value of th_{TA} from UI 1012, to store the value of th_{TA} into memory 1004 via communication channel 1014. In this manner, the value of th_{TA} may be set.

In some embodiments, a user may interact with UI 1012 to change a value of th_{TA} that is currently stored in memory 1004. For example, UI 1012 may be operable to provide a new value of th_{TA} as input by the user to controller 1002 via communication channel 1020. Controller 1002 may be operable to execute instructions in RFM program 1006 to, upon receiving the new value of th_{TA} from UI 1012, to overwrite a currently stored value of th_{TA} in memory 1004 with the new value of th_{TA} into memory 1004 via communication channel 1014. In this manner, the value of th_{TA} may be set.

Returning to FIG. 8A, after the value of th_{TA} is set (8806), a maximum RPM, RPMMax, value is set (S808). For example, as shown in FIG. 9, an RPMMax value is set by RFM system 304. This will be described in greater detail with reference to FIG. 10A.

As shown in FIG. 10A, in operation, the value of RPMMax is set in memory 1004.

For example, in some embodiments, memory 1004 may have the value of RPMMax stored therein as a priori data. In this manner, the value of RPMMax may be set.

In some embodiments, a user may interact with UI 1012 to input the value of RPMMax into memory 1004. For example, UI 1012 may be operable to provide the value of RPMMax as input by the user to controller 1002 via communication channel 1020. Controller 1002 may be operable to execute instructions in RFM program 1006 to, upon receiving the value of RPMMax from UI 1012, to store the value of RPMMax into memory 1004 via communication channel 1014. In this manner, the value of RPMMax may be set.

In some embodiments, a user may interact with UI 1012 to change a value of RPMMax that is currently stored in memory 1004. For example, UI 1012 may be operable to provide a new value of RPMMax as input by the user to controller 1002 via communication channel 1020. Controller 1002 may be operable to execute instructions in RFM program 1006 to, upon receiving the new value of RPMMax from UI 1012, to overwrite a currently stored value of RPMMax in memory 1004 with the new value of RPMMax into memory 1004 via communication channel 1014. In this manner, the value of RPMMax may be set.

Returning to FIG. 7, in this example, the value of RPMMax is set at an absolute of value of 200 RPM, for both: forward rotation, for example, positive or clockwise direction at 200 RPM as indicated by the cap as shown at positive-RPM-period pulse 714; and reverse rotation, for example, negative or counter-clockwise direction at −200 RPM as indicated by the cap as shown at negative-RPM-period pulse 718.

Returning to FIG. 8A, after the value of RPMMax is set (S808), the torque tool is actuated (S810). For example, as shown in FIG. 9, a user presses trigger 105, which causes power source 110 to provide power to RFM system 304 via power line 904.

Returning to FIG. 8A, after the torque tool is actuated (S810), the motor of the torque tool is driven in a first rotation mode (S812). For example, as shown in FIG. 9, RFM system 304 instructs motor 112 to operate in first rotation mode. This will be described in greater detail with reference to FIG. 10A.

As shown in FIG. 10A, controller 1002 receives power from power source 110 via power line 904. Controller 1002 may be operable to execute instructions in RFM program 1006 to generate a drive signal 1022 and transmit drive signal 1022 to motor 112 via communication line 908 and to provide power to motor 112 via power line 906.

Returning to FIG. 9, in response to receiving drive signal 1022 and with the power provided via power line 906, motor 112 operates in a first rotation mode. In this example, the first rotation mode is in a positive or clockwise direction. The positive rotation of motor 112 causes engaging mechanism 114 to rotate in a clockwise direction and turn fastening element in a clockwise direction. Accordingly, torque is applied to fastening element 902 so as to fasten fastening element 902.

Returning to FIG. 6, time t₀ represents the beginning of the first rotation mode of motor 112.

Returning to FIG. 8A, after the motor of the torque tool is driving in a first rotation mode (S812), the value of the RPM of the motor, RPMDet, is detected (S814). For example, as shown in FIG. 9, RFM system 304 detects the value of the RPM of motor 112. This will be described in greater detail with reference to FIG. 10B.

FIG. 10B illustrates a block diagram of RFM system 304 during a parameter detecting state in accordance with aspects of the present disclosure.

As shown in FIG. 10B, rotation sensor 1010 detects the value of RPMDet of motor 112, and provides the detected value of RPMDet of motor 112 to controller 1002 as a detected RPMDet signal 1024 via communication channel 1018.

Returning to FIG. 8A, after the RPMDet, is detected (S814), it is determined whether |RPMDet|=|RPMMax| (S816). For example, as shown in FIG. 9, RFM system 304 determines whether |RPMDet|=|RPMMax|. This will be described in greater detail with reference to FIG. 10B.

As shown in FIG. 10B, controller 1002 executes instructions in RFM program 1006 to cause controller 1002 to obtain the value of RPMMax from RFM program 1006.

In some embodiments, the detected value of RPMDet of motor 112 is based on detected RPMDet signal 1024 such that detected RPMDet signal 1024 includes detected value of RPMDet of motor 112.

In some embodiments, controller 1002 may be operable to execute instructions in RFM program 1006 to cause controller 1002 to generate the detected value of RPMDet of motor 112 from the RPMDet signal 1024, by any known computer-implemented method. In some embodiments, controller 1002 may execute instruction in RFM program 1006 to generate the detected value of RPMDet of motor 112 from the RPMDet signal 1024 via a data structure stored in RFM program 1006 associating distinct RPMDet signals with respective distinct detected value of RPMDet, a non-limiting example of a data structure includes a look-up table. In some embodiments, controller 1002 may execute instruction in RFM program 1006 to generate the detected value of RPMDet of motor 112 from the RPMDet signal 1024 via a predetermined mathematical function stored in RFM program 1006 associating distinct RPMDet signals with respective distinct detected value of RPMDet.

With the absolute value of RPMMax and the absolute value of the detected value of RPMDet of motor 112, controller 1002 may be operable to execute instructions in RFM program 1006 to cause controller 1002 to calculate whether |RPMDet|=|RPMMax|.

Returning to FIG. 8A, if it is determined that |RPMDet|≠|RPMMax|, (N at S816), then the RPM of the motor is increased (S818). For example, as shown in FIG. 9, RFM system 304 causes the motor to increase its RPMs. This will be described in greater detail with reference to FIG. 10A.

As shown in FIG. 10A, controller 1002 may be operable to execute instructions in RFM program 1006 to generate and transmit drive signal 1022 to cause motor 112 to continue to operate in the first rotation mode. Accordingly, this causes a positive rotation of motor 112, which causes engaging mechanism 114 to rotate in a clockwise direction and turn fastening element in a clockwise direction. Accordingly, torque is continued to be applied to fastening element 902 so as to continue to fasten fastening element 902.

Returning to FIG. 8A, after the RPM of the motor is increased (S818), the RPM of the motor is again detected (return to S814) and computer-implemented method 800 continues. For example, returning to FIG. 7, as shown at the beginning of cycle 712 at time 716, the RPM starts increasing.

Alternatively, returning to FIG. 8A, if it is determined that |RPMDet|=|RPMMax|, (Y at S816), then the RPM of the motor is maintained (S820). For example, returning to FIG. 7, if the RPM of motor 112 (RPMDet) equals the maximum predetermined RPMMax, then controller 1002 instructs motor 112 to maintain its RPM via drive signal 1022 and file the power as supplied by power line 906. As shown at the cap of positive-RPM-period pulse 714, the RPM of the motor is maintained at 200 RPMs, which in the example is the predetermined maximum RPM.

Returning to FIG. 8A, after the RPM of the motor is maintained (S820), then as shown in FIG. 8B, which illustrates a second portion of computer-implemented method 800, the torque as applied to the fastening element, T_{D}, is detected (S822). For example, as shown in FIG. 9, the torque as applied to the fastening element, T_{D}, is detected by RFM system 304. This will be described in greater detail with reference to FIG. 10B.

As shown in FIG. 10B, torque detector 1008 detects the value of the magnitude of torque, T_{D}, applied to fastening element 902, and provides the detected value of T_{D} to controller 1002 as a detected torque signal 1026 via communication channel 1016.

Returning to FIG. 8B, after T_{D} is detected (S822), it is determined whether T_{D}=th_{T} (S824). For example, as shown in FIG. 9, RFM system 304 determines whether T_{D}=th_{T}. This will be described in greater detail with reference to FIG. 10B

As shown in FIG. 10B, controller 1002 may be operable to executed instructions in RFM program to cause controller 1002 to retrieve the value of th_{T} from RFM program 1006 and compare the detected value of T_{D} as provided by detected torque signal 1026 with the value of th_{T}.

In some embodiments, the detected value of T_{D} is based on detected torque signal 1026 such that detected torque signal 1026 includes the detected value of T_{D}.

Returning to FIG. 8B, if it is determined that T_{D}≠th_{T} (N at S824), then T_{D} is again detected (return to S822) and computer-implemented method 800 continues. For example, as shown in FIG. 7, consider the function 706 corresponding to the speed command of the motor, the function 708 corresponding to the torque applied to a fastening element by the torque tool. From time 716, the RPM of the motor is increased until it hits a maximum as indicated by a beginning 736 of a cap of positive-RPM-period pulse 714 (See S814, S816 and S818 of FIG. 8A). Then the RPM of the motor is maintained until an end 738 of the cap of positive-RPM-period pulse 714 (See S814, S816 and S820 of FIG. 8A).

Alternatively, if it is determined that T_{D}=th_{T} (Y at S824), then the RPM of the motor of the torque tool is decreased (S826). For example, as shown in FIG. 9, RFM system 304 causes the motor of the torque tool to decrease. This will be described in greater detail with reference to FIG. 10C.

FIG. 10C illustrates a block diagram of RFM system 304 of FIG. 10A after a torque threshold is met in accordance with aspects of the present disclosure.

As shown in FIG. 10C, torque detector 1008 detects the value of the magnitude of torque, T_{D}, applied to fastening element 902, and provides the detected value of T_{D} to controller 1002 as a detected torque signal 1028 via communication channel 1016. Rotation sensor 1010 detects the value of RPMDet of motor 112, and provides the detected value of RPMDet of motor 112 to controller 1002 as a detected RPMDet signal 1030 via communication channel 1018.

Controller 1002 may be operable to execute instructions in RFM program 1006 to cause controller 1002 to generate a drive signal 1032 and transmit drive signal 1032 to motor 112 via communication line 908 and to provide power to motor 112 via power line 906.

Returning to FIG. 9, in response to receiving drive signal 1032 and with the power provided via power line 906, motor 112 operates in a second rotation mode. In this example, the second rotation mode is in a negative or counter-clockwise direction. The negative rotation of motor 112 causes motor 112 to slow down.

Returning to FIG. 8B, after the RPM of the motor of the torque tool is decreased (S826), the RPM of the motor of the torque tool, RPMDet, is detected (S828). This may be performed in a manner as discussed above (see S814). After the RPMDet is detected (S828), it is determined whether |RPMDet|=|RPMMax|(S830). This may be performed in a manner as discussed above (see S816).

If it is determined that |RPMDet|≠|RPMMax|, (N at S830), then the RPM of the motor is decreased (S832). For example, as shown in FIG. 9, RFM system 304 causes the motor to decrease its RPMs. This may be performed in a manner as discussed above (see S826).

Returning to FIG. 8B, after the RPM of the motor is decreased (S832), the RPM of the motor is again detected (return to S828) and computer-implemented method 800 continues. For example, returning to FIG. 7, as shown starting end 738 of the cap of positive-RPM-period pulse 714, the RPM starts decreasing and continues to decrease.

Alternatively, returning to FIG. 8B, if it is determined that |RPMDet|=|RPMMax|, (Y at S830), then the RPM of the motor is maintained (S834). This may be performed in a manner similar to that as discussed above (see S820).

More specifically, as shown in FIG. 7, a beginning 742 of the cap of negative-RPM-period pulse 718 corresponds to when the absolute value of the RPM of the motor meets the predetermined absolute value of the threshold RPM, i.e., when |RPMDet|=|RPMMax|.

Returning to FIG. 8B, the RPM of the motor of the torque tool is increased (S834), then as shown in FIG. 8C, which illustrates a third portion of computer-implemented method 800, the RPMDet is again detected (S836). This may be performed in a manner as discussed above (see S814 in FIG. 8A). Returning to FIG. 8C, after the RPMDet is again detected (S836), it is determined whether RPMDet=0 (S838). For example, as shown in FIG. 9, RFM system 304 determines whether RPMDet=0. This will be described in greater detail with reference to FIG. 10D.

FIG. 10D illustrates a block diagram of RFM system 304 of FIG. 10A during a zero-RPM state in accordance with aspects of the present disclosure.

As shown in FIG. 10D, rotation sensor 1010 detects the value of RPMDet of motor 112, and provides the detected value of RPMDet of motor 112 to controller 1002 as a detected RPMDet signal 1036 via communication channel 1018. Further, torque detector 1008 detects the value of the magnitude of torque, T_{D}, applied to fastening element 902, and provides the detected value of T_{D} to controller 1002 as a detected torque signal 1034 via communication channel 1016. Controller 1002 may be operable to execute instructions in RFM program 1006 to cause controller 1002 to calculate whether the detected RPM of the motor is zero, i.e., whether RPMDet=0.

Returning to FIG. 8C, if it is determined that RPMDet≠0, (N at S838), then the RPM of the motor is increased (S840). This may be performed in a manner similar to that discussed above (see S818). After the RPM of the motor is increased (S840), the RPM of the motor is again detected (return to S836) and computer-implemented method 800 continues. For example, returning to FIG. 7, as shown at an end 744 of negative-RPM-period pulse 718 up to time 724, the RPM continues to increase.

Therefore, in accordance with aspects of the present disclosure, controller 1002 may be operable to execute instructions in RFM program 1006 to modify the length of positive-RPM-period pulse and the length negative-RPM-period pulse in a cycle based on the tth so that the maximum magnitude of torque applied to the fastening element during a single cycle remains below the tth. Because the maximum magnitude of torque applied to the fastening element during a single cycle remains below the tth, the corresponding reaction force required by the user remains below a corresponding amount. Because the torque that is applied to the fastening element may change from one cycle to another, the length of positive-RPM-period pulse and the length negative-RPM-period pulse will correspondingly change from one cycle to another.

Alternatively, returning to FIG. 8C, if it is determined that |RPMDet|=0, (Y at S838), then a period to maintain the RPM of the motor, RPMZero, at zero RPMs is determined (S842). For example, as shown in FIG. 9, RFM system 304 determines a period to maintain the RPM of the motor, RPMZero, at zero RPMs. This will be described in greater detail with reference to FIG. 10E.

FIG. 10E illustrates a block diagram of RFM system 304 in a third operation state in accordance with aspects of the present disclosure.

As shown in FIG. 10E, controller 1002 may be operable to execute instructions in RFM program 1006 to cause controller 1002 to obtain threshold average torque value, th_{TA}, from memory 1004. Controller 1002 may be additionally operable to execute instructions in RFM program 1006 to cause controller 1002 to calculate the value of the average torque, T_{AV}, applied to the fastening element over a current period.

Returning to FIG. 7, for purposes of discussion, consider cycle 712 which starts at time 716 and ends at time 726. The torque applied to the fastening element is only between time 716 through time 724, where the RPM of the motor hits zero.

Although not shown in computer-implemented method 800, torque detector 1008 may periodically detect the torque applied to the fastening element, in addition to the specifically detailed torque detection (see S822).

Returning to FIG. 10E, the value of the periodicity of the torque detection, PTD, of torque detector 1008 may be set in memory 1004.

For example, in some embodiments, memory 1004 may have the value of PTD stored therein as a priori data. In this manner, value of PTD may be set.

In some embodiments, a user may interact with UI 1012 to input the value of PTD into memory 1004. For example, UI 1012 may be operable to provide the value of PTD as input by the user to controller 1002 via communication channel 1020. Controller 1002 may be operable to execute instructions in RFM program 1006 to, upon receiving the value of PTD from UI 1012, to store the value of PTD into memory 1004 via communication channel 1014. In this manner, the value of PTD may be set.

In some embodiments, a user may interact with UI 1012 to change a value of PTD that is currently stored in memory 1004. For example, UI 1012 may be operable to provide a new value of PTD as input by the user to controller 1002 via communication channel 1020. Controller 1002 may be operable to execute instructions in RFM program 1006 to, upon receiving the new value of PTD from UI 1012, to overwrite a currently stored value of PTD in memory 1004 with the new value of PTD into memory 1004 via communication channel 1014. In this manner, the value of PTD may be set.

Returning to FIG. 7, during time period between time 716 and time 724, the torque applied to the fastening element may be detected an integer n times based on PTD, wherein each detected torque value, T_{DI}, may be stored in memory 1004, wherein i is the set of 1 through n. Returning to FIG. 10E, controller 1002 may be operable to execute instructions in RFM program 1006 to obtain the n values of the detected torque values, T_{DI}, from memory 1004. Controller 1002 may additionally be operable to execute instructions in RFM program 1006 to calculate an average torque value, T_{AV}, by dividing the sum of the n values of the detected torque values, T_{DI}, by the number n of the detected torque values.

Returning to FIG. 7, for cycle 712, T_{AV} corresponds to the average torque applied to the fastening element from time 716 through time 724. In accordance with aspects of the present disclosure, controller 1002 may additionally be operable to execute instructions in RFM program 1006 to calculate the time period between time 724 and time 726, wherein the motor will be instructed to operate in a third rotation mode, wherein the motor operates at zero RPMs. In other words, each period ends with a zero-RPM time period corresponding to a zero RPM rotation mode of the motor. For example, cycle 712 ends with zero-RPM time period 722.

In an example embodiment, controller 1002 may additionally be operable to execute instructions in RFM program 1006 to calculate the length of the zero-RPM time period for each cycle. In an example embodiment, controller 1002 may additionally be operable to execute instructions in RFM program 1006 to calculate the length of the zero-RPM time period for each cycle such that the average torque value, T_{AV}, for a current cycle is less than predetermined average torque threshold, th_{TA} (see S806 in FIG. 8).

Returning to FIG. 8C, after RPMZero is determined (S842), the RPM for the motor of the torque tool is maintained at zero for RPMZero (S844). For example, as shown in FIG. 9, RFM system 304 instructs the motor of the torque tool to maintain zero RPMs for the determined zero-RPM time period, RPMZero. This will be described in greater detail with reference to FIG. 10E.

As shown in FIG. 10E, controller 1002 may be operable to execute instructions in RFM program 1006 to cause controller 1002 to generate a drive signal 1038 and transmit drive signal 1038 to motor 112 via communication line 908 and to provide power to motor 112 via power line 906.

Returning to FIG. 9, in response to receiving drive signal 1038 and with the power provided via power line 906, motor 112 operates in a third rotation mode. In this example, the third rotation mode is in a zero-RPM mode.

Therefore, in accordance with aspects of the present disclosure, controller 1002 may be operable to execute instructions in RFM program 1006 to modify the length of the zero-RPM time period so that the average torque applied to the fastening element throughout whole cycle, is less than a predetermined torque threshold. Because the torque that is applied to the fastening element may change from one cycle to another, the zero-RPM time period will correspondingly change from one cycle to another.

Returning to FIG. 8C, after maintaining the RPM for the motor of the torque tool at zero for RPMZero (S844), it is determined whether the torque tool is actuated (S846). For example, as shown in FIG. 9, if trigger 105 is actuated, then power source 110 provides power to RFM system 304 via power line 904. Upon receiving power from power source 110, RFM system 304 determines that torque tool 300 is actuated.

Returning to FIG. 8C, if it is determined that the torque tool is actuated (Y at S846), then the motor of the torque tool is driven in the first rotation mode (return to S812 as shown in FIG. 8A), and computer-implemented method 800 continues. Returning to FIG. 8C, alternatively, if it is determined that the torque tool is not actuated (N at S846), then computer-implemented method 800 stops (S848).

In the example embodiments discussed above with reference to FIGS. 4A-10E, the reaction force of a torque tool is mitigated by pulsing the speed command to the motor of the torque tool, wherein: first, the torque tool is driven in a first operation mode (for example in a clockwise direction) to apply torque to a fastening element; and second, the torque tool is driven in a second operation mode when the torque hits a predetermined torque threshold so as to apply the speed command in an opposite direction (for example in a counter-clockwise direction). Then there is an OFF period wherein the torque tool is not driven. Further, each OFF period between pulses is determined so as to maintain an average torque applied to the fastening element that is below an average torque threshold.

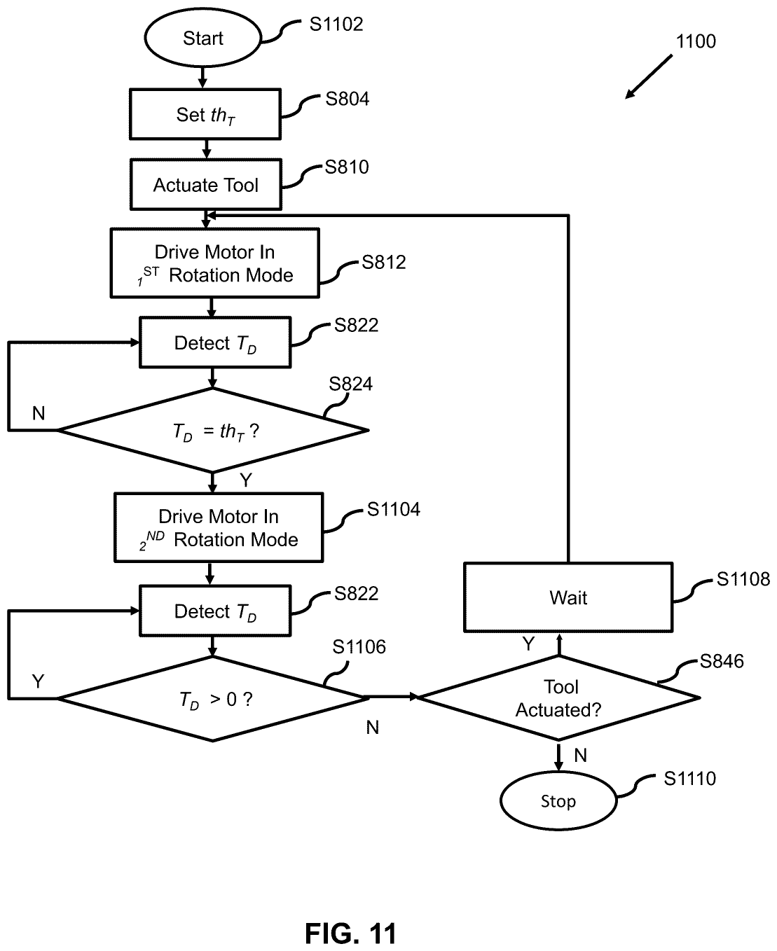

In other embodiments, as opposed to driving the motor in a clockwise and then counter-clockwise direction, the motor is driven in a first direction until a torque threshold is detected. Then the motor is stopped, without providing a driving signal to drive the motor in an opposite direction. In particular, in some embodiments, the motor is stopped by providing a zero current to the motor such that the motor will coast to a stop. In some embodiments, the motor may be further shorted so as to provide a hard brake to the motor. These embodiments will now be described in greater detail with reference to FIGS. 11-15C.

FIG. 11 illustrates a computer-implemented method 1100 of operating a torque tool in accordance with aspects of the present disclosure.

As shown in the figure, computer-implemented method 1100 starts (S1102) and a threshold torque, th_{T}, is set (S804). This process may be performed in a manner as discussed above with reference to FIG. 8A.

After a threshold torque th_{T}, is set (S804), the tool is actuated (S810). This process may be performed in a manner a discussed above with reference to FIG. 8A.

After the tool is actuated (S810), the motor is driven in the 1 st rotation mode (S812). This process may be performed in a manner as discussed above with reference to FIG. 8A.

After the motor is driven in the 1st rotation mode (S812), the torque as applied to the fastening element, T_{D}, is detected (S822). This process may be performed in a manner as discussed above with reference to FIG. 8B.

After the torque as applied to the fastening element, T_{D}, is detected (S822), it is determined whether T_{D}=th_{T} (S824). This process may be performed in a manner as discussed above with reference to FIG. 8B.

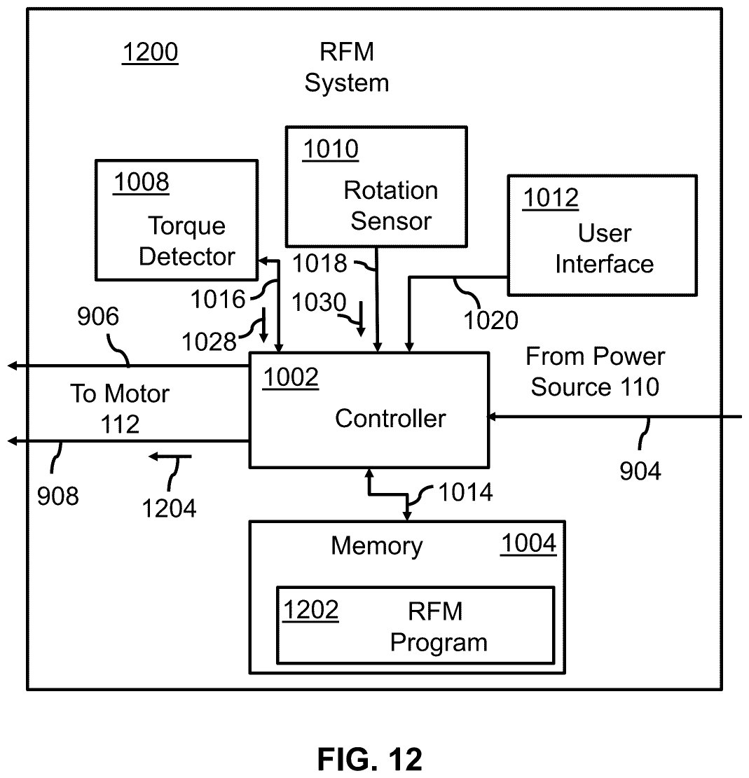

If it is determined that T_{D}≠th_{T} (N at S824), then T_{D} is again detected (return to S822) and computer-implemented method 1100 continues. Alternatively, if it is determined that T_{D}=th_{T} (Y at S824), then the motor is driven in a second rotation mode (S1104). In the second rotation mode, the motor is driven to stop. This will be described in greater detail with reference to FIG. 12.

FIG. 12 illustrates a block diagram of an RFM system 1200 during an initial operation state in accordance with aspects of the present disclosure.

As shown in the figure, RFM system 1200 differs from RFM system 304 in that in RFM system 1200, RFM program 1006 in memory 1004 has been replaced with RFM program 1202.

In RFM system 1200, memory 1004, as will be described in greater detail below, has instructions, including RFM program 1202, stored therein to be executed by controller 1002 causing RFM system 1200 to: compare the magnitude of torque based on the torque signal to th_{T}; output the first drive signal when th_{T}>T_{D}; output the second drive signal when th_{T}≤T_{D}; output the first drive signal as a drive current; and output the second drive signal as a zero drive current.

In some embodiments, memory 1004, as will be described in greater detail below, has instructions to be executed by controller 1002 causing RFM system 1200 to output the second drive signal a time period after a time when th_{T}≤T_{D}.

In some embodiments, motor 112 comprises a plurality of phase windings, each of which provides a respective voltage phase, and memory 1004, has instructions, including RFM program 1202, stored therein to be executed by controller 1002 causing RFM system 1200 to: output the second drive signal so as to disconnect the plurality of phase windings so as to output the zero drive current; and subsequently output a third drive signal so as to short the plurality of phase windings with one another.

In operation, controller 1002 may be operable to execute instructions in RFM program 1202 to cause controller 1002 to generate a drive signal 1204 and transmit drive signal 1204 to motor 112 via communication line 908. Drive signal 1204 causes motor 112 to stop.

Returning to FIG. 11, after the motor is driven in a second rotation mode (S1104), the torque as applied to the fastening element, T_{D}, is detected (S822). This process may be performed in a manner as discussed above with reference to FIG. 8B. After the torque as applied to the fastening element, T_{D}, is detected (S822), it is determined whether T_{D}>0 (S1106). For example, as shown in FIG. 12, torque detector 1008 is operable to detect the torque applied to a fastening element by the torque tool and provide the value of the detected torque, T_{D}, to controller 1002 in a detected torque signal. Controller 1002 may be operable to execute instructions in RFM program 1202 to calculate if the value of T_{D} is greater than zero.

If it is determined that T_{D}>0 (Y at S1106), then T_{D} is again detected (return to S822) and computer-implemented method 1100 continues. Alternatively, if it is determined that T_{D}≤0 (N at S1106), then it is determined whether the torque tool is actuated (S846). This process may be performed in a manner as discussed above with reference to FIG. 8C. If it is determined that the torque tool is not actuated (N at S846), then computer-implemented method 1100 stops (S1110). Alternatively, if it is determined that the torque tool is actuated (Y at S846) then a period of time is waited (S1108).

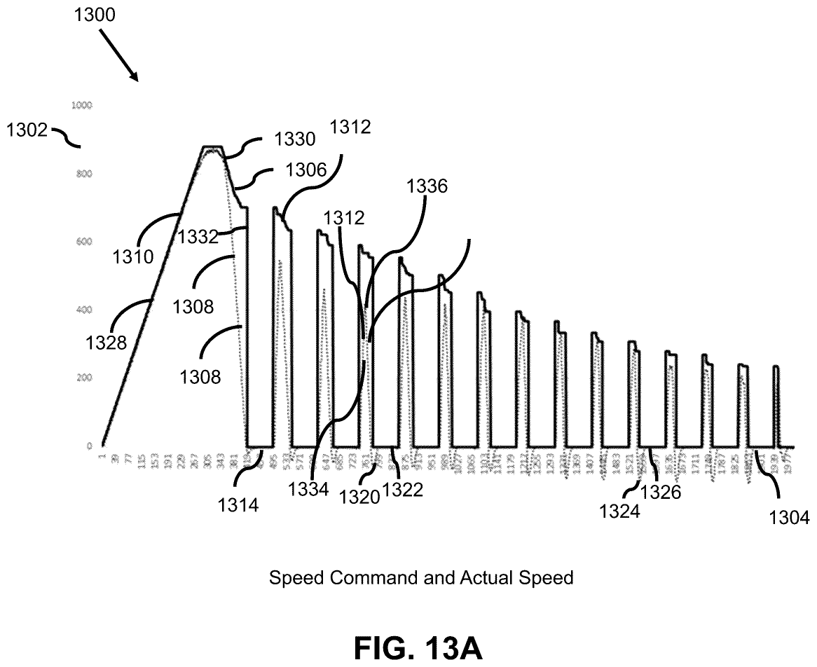

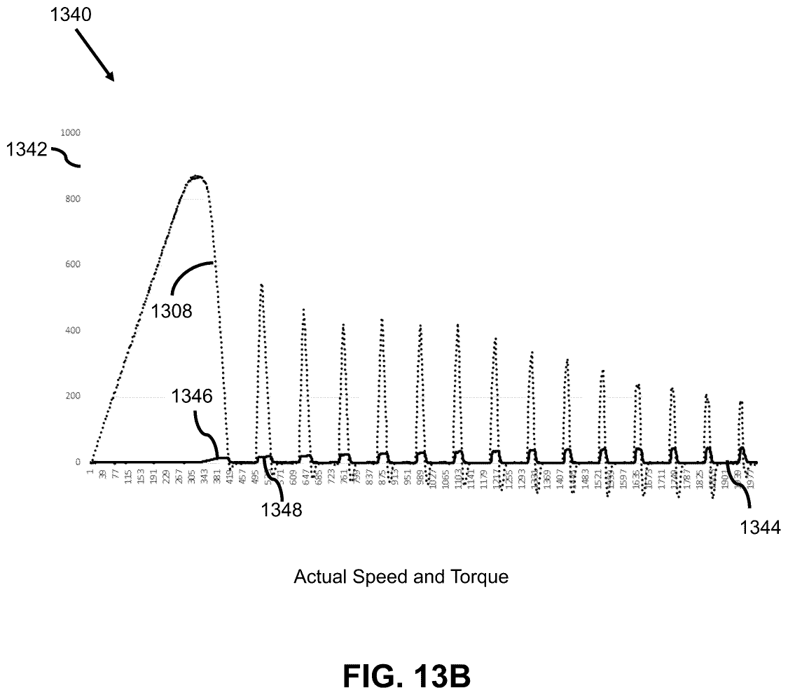

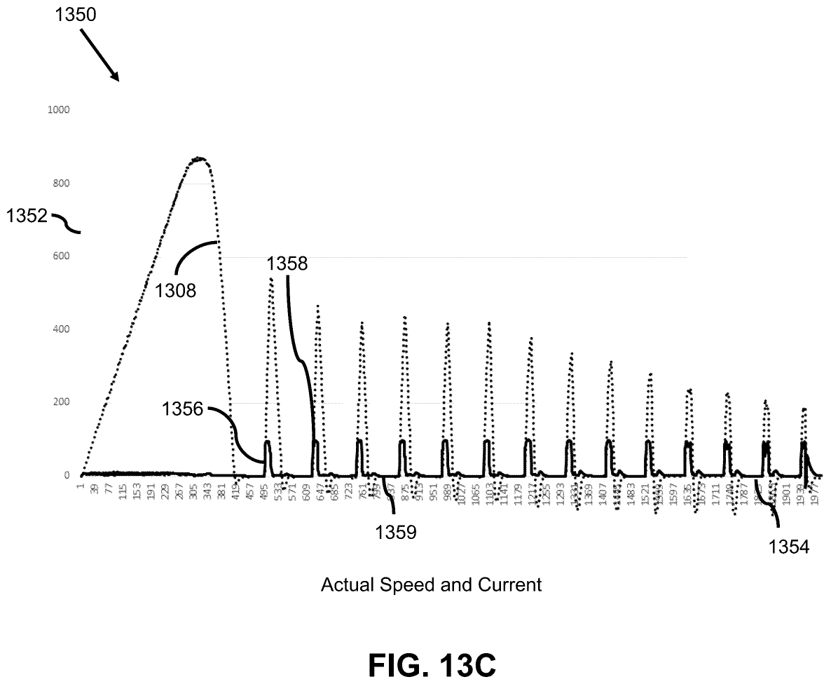

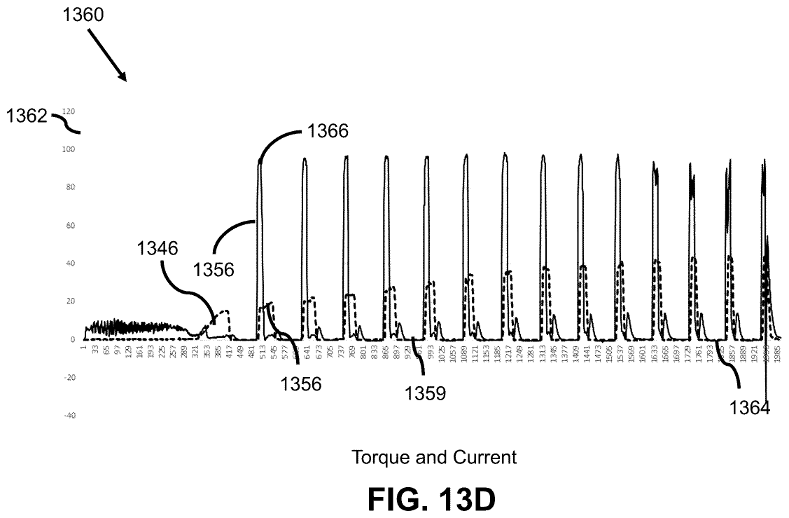

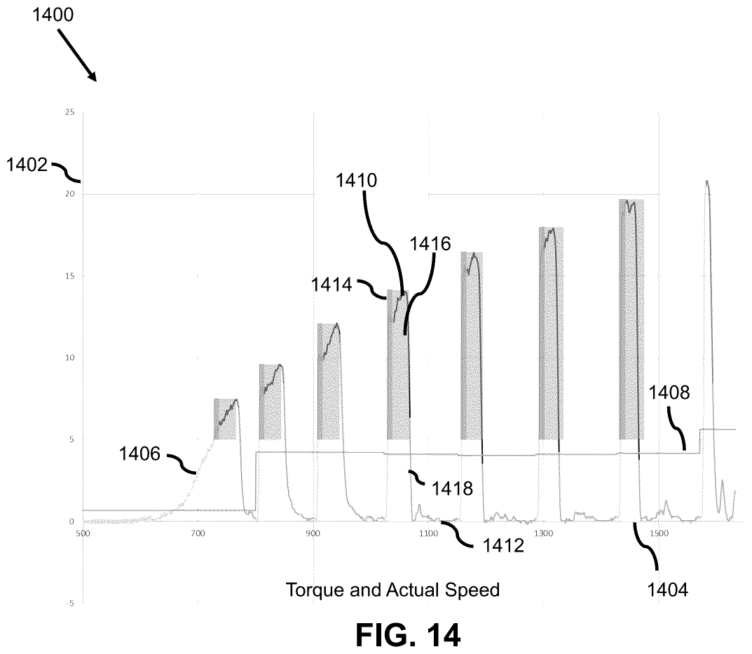

For example, as shown in FIG. 12, RFM system 1200 determines a period to wait before providing another drive current pulse to drive motor 112. In an example embodiments, the period of time t₀ wait is determined based on maintaining an average applied torque. This will be described in greater detail with reference to FIGS. 13A-14.

FIG. 13A illustrates a graph 1300 of a speed command provided to motor 112 and actual speed of motor 112.

As shown in the figure, graph 1300 includes a y-axis 1302, an x-axis 1304, a speed command function 1306, and a motor speed function 1308. Y-axis is speed and is measured in units of revolutions per minute (RPMs). X-axis 1304 is time and is measured in units of milliseconds. Speed command function 1306 corresponds to the speed command provided to motor 112 from controller 1002. Speed command function 1306 includes a plurality of pulses, a sample of which are labeled as pulses 1310 and 1312, wherein the pulses are separated from one another by a speed command OFF period, a sample of which is labeled as speed command OFF period 1314. Motor speed function 1308 corresponds to the actual speed of motor 112 as a result of the speed command provided to motor 112 from controller 1002. Motor speed function 1308 includes a plurality of pulses, a sample of which are labeled as pulses 1316 and 1318, wherein the pulses are separated from one another by a negative actual speed transient followed by an actual speed OFF period, a sample of which is labeled as a negative actual speed transient 1320 followed by an actual speed OFF period 1322 and a negative actual speed transient 1324 followed by an actual speed OFF period 1326.

Graph 1300 shows that the actual speed of motor 112 is not exactly the same as the speed command, which corresponds to drive signals provided by controller 1002. Speed command function 1306 shows that a pulse from the speed command includes: a rise, a sample of which is labeled as rise 1328 of pulse 1306; a crest portion, a sample of which is labeled as crest portion 1330 of pulse 1306; and a fall, a sample of which is labeled as fall 1332 of pulse 1306. Motor speed function 1308 shows that a pulse from the actual speed of the motor includes: a rise, a sample of which is labeled as rise 1334 of pulse 1312; a crest portion, a sample of which is labeled as crest portion 1336 of pulse 1312; a fall, a sample of which is labeled as fall 1338 of pulse 1312; and a negative transient, a sample of which is a negative actual speed transient 1320 of pulse 1312.

FIG. 13B illustrates a graph 1340 of the actual speed of motor 112 and torque.

As shown in the figure, graph 1300 includes a y-axis 1342, an x-axis 1344, motor speed function 1308, and a torque function 1346. Y-axis plays a dual role, wherein it is speed and is measured in units of revolutions per minute (RPMs) with respect to motor speed function 1308 and is torque with respect to torque function 1346 and is measured in NM. X-axis 1344 is time and is measured in units of milliseconds. Torque function 1346 corresponds to the torque applied to a fastening element by the torque tool. Torque function 1346 includes a plurality of pulses, a sample of which is labeled as pulse 1348, wherein the pulses align with the pulses of motor speed function 1308.

FIG. 13C illustrates a graph 1350 of the actual speed of motor 112 and current.

As shown in the figure, graph 1500 includes a y-axis 1352, an x-axis 1354, motor speed function 1308, and a current function 1356. Y-axis plays a dual role, wherein it is speed and is measured in units of revolutions per minute (RPMs) with respect to motor speed function 1308 and is current and is measured in mA with respect to current function 1356. X-axis 1344 is time and is measured in units of milliseconds. Current function 1356 corresponds to the current supplied to motor 112 to drive motor 112. Current function 1356 includes a plurality of pulses, a sample of which is labeled as pulse 1358, wherein the pulses align with the pulses of motor speed function 1308. Further, the pulses are separated from one another by a precisely controlled respective period of time, a sample of which is indicated as period 1359. As will be described in greater detail below, this zero current time separating respective neighboring pulses enables controller 1002 to maintain an average torque throughout activation of the torque tool.

FIG. 13D illustrates a graph 1360 of the torque and current.

As shown in the figure, graph 1360 includes a y-axis 1362, an x-axis 1364, torque function 1346, and current function 1356. Y-axis plays a dual role, wherein it is torque and is measured in units of NM with respect to torque function 1346 and is current and is measured in mA with respect to current function 1356. X-axis 1364 is time and is measured in units of milliseconds.

Graph 1360 shows that a current pulse starts and torque is generated, as evidenced by the start of current pulse 1366 of current function 1356 initiating torque pulse 1356 of torque function 1346 for example. This is because when current is supplied to motor 112, the motor turns, which ultimately generates the torque applied to the fastening element by the torque tool. The current then drops to zero when the torque hits the predetermined threshold. Although the current supplied to motor 112 is quickly reduced to zero, the torque applied to the fastening element continues for a bit as a result of the momentum in the rotor of motor 112. This is evidenced by the continuing short rise in each torque pulse even after the corresponding current pulse ends, as evidenced for example by torque pulse 1356 of torque function 1346 as compared to current pulse 1366 of current function 1356.

Overall, in accordance with aspects of the present disclosure, as shown in FIGS. 13A-D, speed command function 1306 is provided so as to maximize rotation of the rotor of motor 112 for each driving period. Further, current function 1356 is provided as a step function, wherein each pulse of current function 1356 falls when the corresponding detected torque meets a predetermined threshold. Still further, the zero-current period between neighboring current pulses is established so as to enable controller 1002 to maintain an average torque throughout activation of the torque tool. This will be described in greater detail with reference to FIG. 14.

FIG. 14 illustrates a graph 1400 of actual speed of motor 112 and torque.

As shown in the figure, graph 1400 includes a y-axis 1402, an x-axis 1404, a motor speed function 1406 and a torque function 1408. Y-axis is speed and is measured in units of revolutions per minute (RPMs). X-axis 1404 is time and is measured in units of milliseconds. Motor speed function 1406 corresponds to the actual speed of motor 112 as a result of the speed command provided to motor 112 from controller 1002. Speed command function 1406 includes a plurality of pulses, a sample of which is labeled as pulse 1410, wherein the pulses are separated from one another by an actual speed OFF period, a sample of which is labeled as an actual speed OFF period 1412.

The actual speed OFF periods between pulses correspond to respective zero current periods (not shown), but are discussed above with reference to FIG. 13C. Further, it should be noted that each actual speed pulse of motor speed function 1406 includes: a first rotation mode portion, a second rotation mode portion, and a third rotation mode portion—when needed.

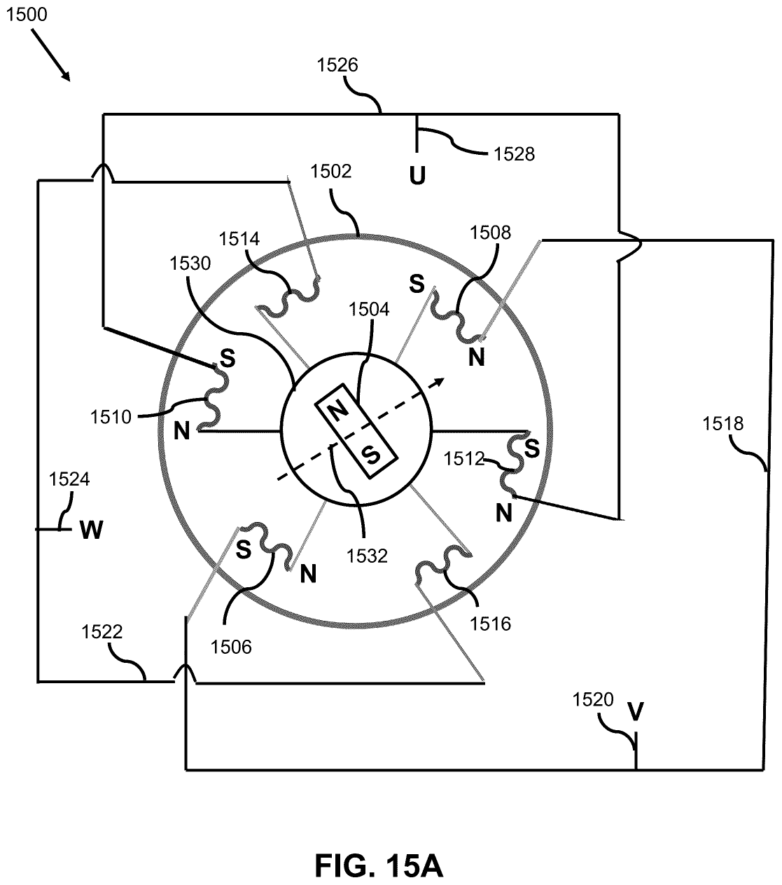

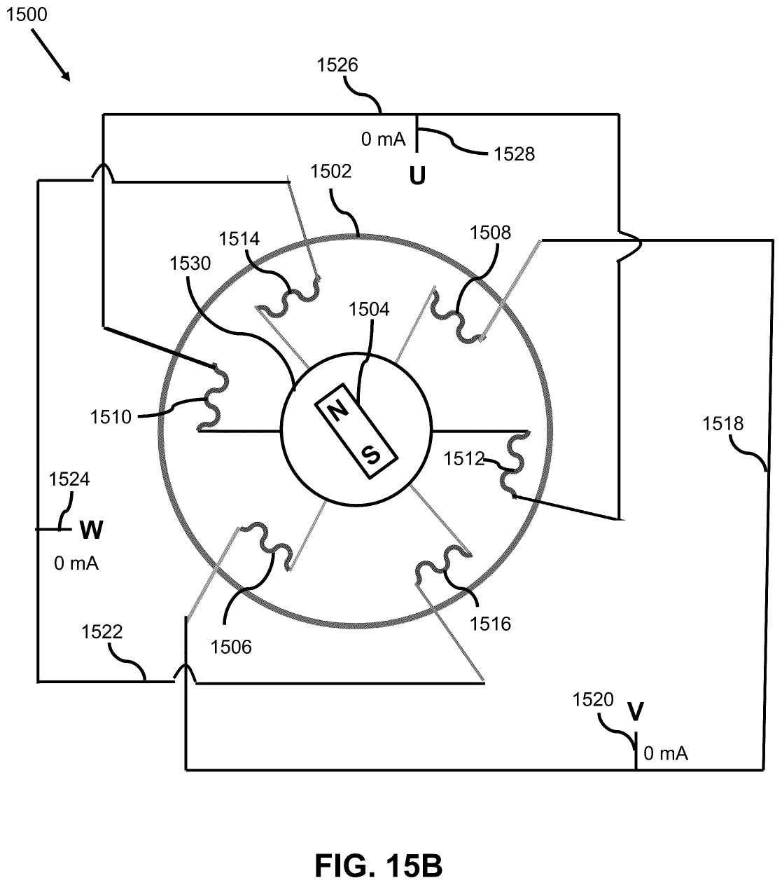

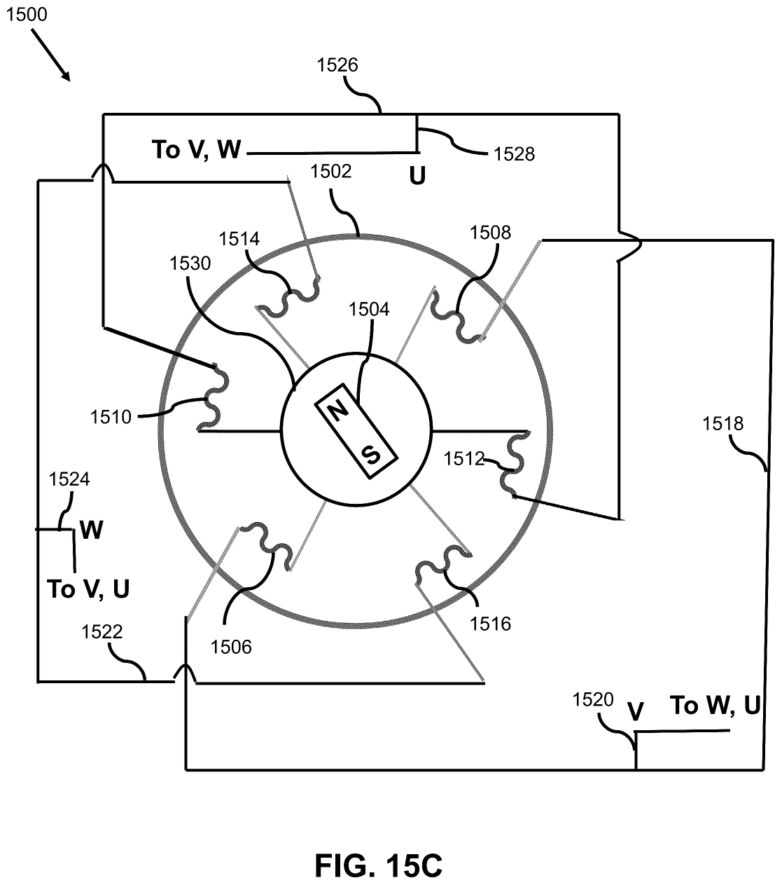

In the first rotation mode portion of a pulse, the actual speed of motor 112 is running in a first rotation mode so as to apply torque to fastening element 902 so as to fasten fastening element 902. These first mode portions are highlighted in the figure with dark rectangles, an example of which is labeled as first rotation mode portion 1414 of pulse 1410. The first rotation mode will be described in greater detail with reference to FIG. 15A.

FIG. 15A represents a circuit diagram 1500 of a motor within a torque tool in accordance with aspects of the present disclosure at a time t₀.

As shown in the figure, circuit diagram 1500 includes a stator 1502, a rotor 1504, a winding 1506, a winding, 1508, a winding 1510, a winding 1512, a winding 1514, a winding 1516, a feed line 1508 having an input 1520, a feed line 1522 having an input 1524, a feed line 1526 having an input 1528, and a common connection 1530.

Stator 1502 is operable to surround rotor 1504. In this example, rotor 1504 is represented by a single magnet. It should be noted that any known rotor/stator configuration may be implemented in accordance with aspects of the present disclosure, so long as the driving is performed in a manner in accordance with aspects of the present disclosure.

Winding 1506 is operable to electrically connect to feed line 1518 and to common connection 1530. Winding 1508 is operable to electrically connect to feed line 1518 and to common connection 1530. Accordingly winding 1506 and winding 1508 are configured such that as current through each winding, a magnetic field that is generated within winding 1506 has an opposite polarity to a magnetic field that is generated within winding 1508.

Winding 1510 is operable to electrically connect to feed line 1526 and to common connection 1530. Winding 1512 is operable to electrically connect to feed line 1526 and to common connection 1530. Accordingly winding 1510 and winding 1512 are configured such that as current through each winding, a magnetic field that is generated within winding 1510 has an opposite polarity to a magnetic field that is generated within winding 1512.

Winding 1514 is operable to electrically connect to feed line 1524 and to common connection 1530. Winding 1516 is operable to electrically connect to feed line 1524 and to common connection 1530. Accordingly winding 1514 and winding 1516 are configured such that as current through each winding, a magnetic field that is generated within winding 1514 has an opposite polarity to a magnetic field that is generated within winding 1516.

For purposes of simplicity only: let the circuit including input line 1520, feed line 1518, winding 1506 and winding 1508 be considered an circuit V; let the circuit including input line 1524, feed line 1522, winding 1514 and winding 1516 be considered an circuit W; and let the circuit including input line 1528, feed line 1526, winding 1510 and winding 1512 be considered an circuit U.

At time t₀, a current is passed through circuit V such that winding 1506 generates a magnetic field having a N/S arrangement as shown in the figure and winding 1508 generates a magnetic field having an opposite N/S arrangement as shown in the figure. Further, a current is passed through circuit V such that winding 1510 generates a magnetic field having a N/S arrangement as shown in the figure and winding 1512 generates a magnetic field having an opposite N/S arrangement as shown in the figure.

Accordingly, windings 1508 and 1512 generate combined S polarity magnetic fields, whereas windings 1506 and 1510 generate combined N polarity magnetic fields generated at and a current is passed through circuit U such that winding 1516 generates a magnetic field having a N/S arrangement as indicated in the figure as indicated in the figure. Accordingly an overall magnetic field 1532 is generated wherein the N end is arranged between windings 1506 and 1510 and the S end is arranged between windings 1508 and 1512. Accordingly, the S pole of rotor 1504 will be repelled from windings 1508 and 1512 and will be drawn to windings 1510 and 1506. On the other hand, the N pole of rotor 1504 will be repelled from windings 1510 and 1506 and will be drawn to windings 1508 and 1512 This rotor 1504 will spin.

Currents may be provided to circuits U, V, and W in a phase-driven manner to spin rotor 1504, and is well known in the art and will not be further described here for purposes of brevity. This driving scheme corresponds to the first rotation mode. For example, driving rotor 1504 in the manner as discussed above with reference to FIG. 15A corresponds to the first rotation mode portion, wherein the actual speed of motor 112 is running in a first rotation mode so as to apply torque to fastening element 902 so as to fasten fastening element 902, an example of which is labeled as first rotation mode portion 1414 of pulse 1410 discussed above with reference to FIG. 14.

In the second rotation mode, the actual speed of motor 112 is running in a second rotation mode, wherein motor 112 is electrically disconnected. In this second rotation mode, the motor will continue to rotate. However, the rotation is not driven as motor 112 has been electrically disconnected. In this second rotation mode, motor 112 continues to rotate as a result of its rotational momentum. The disconnected windings (not shown) in motor 112 enable the rotor to continue rotating due to inertia. In this second rotation mode, energy is still poured into rotating the fastening element. Further, by disconnecting the windings in motor 112, less heat is generated by the motor. These second mode portions are highlighted in the figure with light rectangles, an example of which is labeled as second rotation mode portion 1416 of pulse 1410. The second rotation mode will now be described with reference to FIG. 15B.

FIG. 15B represents circuit diagram 1500 at a time t1.

As shown in the figure, each of windings 1506, 1508, 1510, 1512, 1514, and 1516 are disconnected such current through each of circuits U, V, and W is zero mA. This may be accomplished by any known controllable switching mechanism for electrical circuits. Accordingly, there is no magnetic push/pull created by the windings to act on rotor 1504. Therefore, rotor 1504 starts to stop spinning. This driving scheme corresponds to the second rotation mode. For example, driving rotor 1504 in the manner as discussed above with reference to FIG. 15B corresponds to the second rotation mode portion, wherein the actual speed of motor 112 is running in disconnect portion of the second rotation mode wherein motor 112 is disconnected such that the rotor of motor 112 coasts, a sample of which includes motor disconnect portion 1418 of second rotation mode portion 1416 of pulse 1410 discussed above with reference to FIG. 14.

In some instances, motor 112 does not stop in time to maintain an acceptable level of reaction and control so as to minimize torque overshoot. In these cases, motor may be driven in the third rotation mode, wherein the windings of motor 112 are shorted together. In the third rotation mode, the motor is aggressively being driven to zero speed so as to stop applying torque to fastening element 902 so as to stop fastening element 902. These third mode portions are after the second mode portion, but prior to the actual speed OFF period, an example of which is labeled as third rotation mode portion 1418 of pulse 1410, which is after second rotation mode portion 1416, but prior to actual speed OFF period 1412. This will now be described with reference to FIG. 15C.

FIG. 15C represents circuit diagram 1500 at a time t2.

As shown in the figure, each of circuits U, V, and W are shorted together. This may be accomplished by any known controllable switching mechanism for electrical circuits. Accordingly, there is no driving current supplied to any of circuits U, V, and W, such that there is no magnetic push/pull created by the windings to act on rotor 1504, in a manner similar to that discussed above with reference to FIG. 15A. Further, as rotor 1504 passes each winding, the magnetic field of rotor 1504 will generate a current in the winding. Because each wining is shorted together, all windings will have the same generated current, which greatly slows rotor. An analogy would be similar to rotor 1504 spinning through a viscous fluid. The “friction” of the fluid would greatly reduce the spin of rotor 1504. This driving scheme corresponds to optional variation of the second rotation mode. For example, driving rotor 1504 in the manner as discussed above with reference to FIG. 15C corresponds to the third rotation mode portion, wherein the actual speed of motor 112 is running in a third rotation mode (or motor-shorted portion of the second rotation mode), wherein motor 112 is shorted such that the rotor of motor 112 performs a hard brake, a sample of which includes third rotation portion 1418 of pulse 1410 discussed above with reference to FIG. 14.

In FIG. 14, graph 1400 illustrates that the controlled revolutions of the rotor of motor 112, based on controlling current to motor 112, result in maintaining an average torque, T_{AV}, applied to fastening element 902 so as to fasten fastening element 902 to be below the predetermined average torque threshold, th_{TA}. In this example, the average target torque is 10 Nm.

Returning to FIG. 11, after the motor is driven in a second rotation mode (S1108), it is determined whether the torque tool is actuated (S846). This process may be performed in a manner as discussed above with reference to FIG. 8C. If it is determined that the torque tool is actuated (Y at S846), then the motor of the torque tool is driven in the first rotation mode (return to S812), and computer-implemented method 1100 continues. Alternatively, if it is determined that the torque tool is not actuated (N at S846), then computer-implemented method 1100 stops (S1110).

A problem with prior art torque tools is that a reaction force is created that spins the torque tool in the hand of the user. To prevent the torque tool from spinning, the user must apply an equal and opposite force, which creates discomfort to the user. Alternatively, a reaction bar may be used, wherein the torque tool may include a reaction bar that must either rest against an immovable object or be held by the use so as to prevent the torque tool from spinning.

In accordance with aspects of the present disclosure, a torque tool is provided that includes a reaction force mitigation (RFM) system that reduces the magnitude of reaction force applied to a torque tool over a period of time.

In some embodiments, the RMF system reduces the reaction force by pulsing the motor of the torque tool, wherein the pulses include a positive rotation of the motor, followed by a negative rotation of the motor, followed by no rotation of the motor. In these embodiments, the period of the negative rotation of the motor and the period of no rotation of the motor is determined so as to maintain a predetermined average torque threshold.

In some embodiments, the RMF system reduces the reaction force by pulsing the motor of the torque tool, wherein the pulses include a driving of the motor, followed by a non-driving of the motor by providing zero current to the motor. In some embodiments the non-driving of the motor includes shorting the motor after providing zero current to the motor. The period of non-driving the motor is determined so as to maintain a predetermined average torque threshold.

The terms “coupled,” “attached,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to enable others skilled in the art to best utilize the invention in various embodiments and with various modifications as are suited to the particular use contemplated. It is intended that the scope of the invention be defined by the claims appended hereto.

### EXAMPLES

The disclosure further includes additional notes and examples, as set forth in the following clauses and subclauses.

### Clause A

A reaction force mitigation (RFM) system for a torque tool having an engaging mechanism and a motor, the RFM system including one or more of the following: a torque detector operable to detect a magnitude of torque (T_{D}) applied to a fastening element by the torque tool and output a torque signal based on the detected T_{D}; and a controller having one or more processors that are operable to perform operations that include: outputting a first drive signal to cause the motor to operate in a first rotation mode and outputting a second drive signal to cause the motor to operate in a second rotation mode based on the torque signal.

### Subclauses A1-A20

A1. In accordance with any RFM system set forth and described herein, in the first rotation mode of the motor, the engaging mechanism is rotated at a first rate to transfer a first torque to the fastening element.

A2. In accordance with any RFM system set forth and described herein, in the second rotation mode of the motor, the engaging mechanism is rotated at a second rate to transfer a second torque to the fastening element.

A3. In accordance with any RFM system set forth and described herein, a non-transitory memory is provided having instructions of computer-executable program code, which when executed by the one or more processors of the controller, causes the controller to perform operations that include storing a threshold torque value (th_{T}) in the non-transitory memory.

A4. In accordance with any RFM system set forth and described herein, the instructions of computer-executable program code, which when executed by one or more processors of the controller, causes the controller to perform operations that include comparing the magnitude of torque based on the torque signal to th_{T}.

A5. In accordance with any RFM system set forth and described herein, the instructions of computer-executable program code, which when executed by one or more processors of the controller, causes the controller to perform operations that include outputting the first drive signal when th_{T}>T_{D}

A6. In accordance with any RFM system set forth and described herein, the instructions of computer-executable program code, which when executed by one or more processors of the controller, causes the controller to perform operations that include outputting the second drive signal when th_{T}≤T_{D}.

A7. In accordance with any RFM system set forth and described herein, th_{T} is less than 50 NM.

A8. In accordance with any RFM system set forth and described herein, the instructions of computer-executable program code, which when executed by one or more processors of the controller, causes the controller to perform operations that include outputting the second drive signal a time period after a time when th_{T}≤T_{D}.

A9. In accordance with any RFM system set forth and described herein, the motor has a plurality of phase windings, each of which provides a respective voltage phase.

A10. In accordance with any RFM system set forth and described herein, the instructions of computer-executable program code, which when executed by one or more processors of the controller, causes the controller to perform operations that include outputting the second drive signal to cause disconnection of the plurality of phase windings and thereby output a zero drive current.

A11. In accordance with any RFM system set forth and described herein, the instructions of computer-executable program code, which when executed by one or more processors of the controller, causes the controller to perform operations that include outputting a third drive signal to cause shorting of the plurality of phase windings with one another.

A12. In accordance with any RFM system set forth and described herein, the instructions of computer-executable program code, which when executed by one or more processors of the controller, causes the controller to perform operations that include outputting the first drive signal as a drive current.

A13. In accordance with any RFM system set forth and described herein, the instructions of computer-executable program code, which when executed by one or more processors of the controller, causes the controller to perform operations that include outputting the second drive signal as a zero drive current.

A14. In accordance with any RFM system set forth and described herein, the instructions of computer-executable program code, which when executed by one or more processors of the controller, causes the controller to perform operations that include outputting the first drive signal a predetermined time period after outputting the second drive signal.

A15. In accordance with any RFM system set forth and described herein, the torque detector comprises a strain gauge transducer.

A16. In accordance with any RFM system set forth and described herein, a user interface is provided and operable to facilitate a user to set the threshold torque value (th_{T}) as an input value and also change the threshold torque value (th_{T}).

A17. In accordance with any RFM system set forth and described herein, the motor is additionally operable to operate in a third rotation mode so as to not rotate the engaging mechanism and thereby cause the engaging mechanism to transfer a third torque to the fastening element.

A18. In accordance with any RFM system set forth and described herein, the instructions of computer-executable program code, which when executed by one or more processors of the controller, causes the controller to perform operations that include outputting, when th_{T}-=T_{D}, a third drive signal after outputting the second drive signal.

A19. In accordance with any RFM system set forth and described herein, the instructions of computer-executable program code, which when executed by one or more processors of the controller, causes the controller to perform operations that include calculating an average torque value (T_{AV}).

A20. In accordance with any RFM system set forth and described herein, the instructions of computer-executable program code, which when executed by one or more processors of the controller, causes the controller to perform operations that include calculating, after outputting a third drive signal and based on T_{AV}, a time (t) to output the first drive signal such that T_{AV} is less than or equal to a threshold average torque value, th_{TA}.

### Clause B

A torque tool that includes one or more of the following: an engaging mechanism; a motor that is operable in a plurality of operating modes that include a first rotation mode to rotate the engaging mechanism at a first rate to transfer a first torque to a fastening element, and a second rotation mode to rotate the engaging mechanism at a second rate to transfer a second torque to the fastening element; a torque detector operable to detect a magnitude of torque (T_{D}) applied to the fastening element and to output a torque signal based on T_{D}; and a controller having one or more processors that are operable to perform operations that include: outputting a first drive signal to cause the motor to operate in the first rotation mode and outputting a second drive signal to cause the motor to operate in the second rotation mode based on the torque signal.

### Subclauses B1-B20

B1. In accordance with any torque tool set forth and described herein, in the first rotation mode of the motor, the engaging mechanism is rotated at a first rate to transfer a first torque to the fastening element.

B2. In accordance with any torque tool set forth and described herein, in the second rotation mode of the motor, the engaging mechanism is rotated at a second rate to transfer a second torque to the fastening element.

B3. In accordance with any torque tool set forth and described herein, a non-transitory memory is provided having instructions of computer-executable program code, which when executed by the one or more processors of the controller, causes the controller to perform operations that include storing a threshold torque value (th_{T}) in the non-transitory memory.

B4. In accordance with any torque tool set forth and described herein, the instructions of computer-executable program code, which when executed by one or more processors of the controller, causes the controller to perform operations that include comparing the magnitude of torque based on the torque signal to th_{T}.

B5. In accordance with any torque tool set forth and described herein, the instructions of computer-executable program code, which when executed by one or more processors of the controller, causes the controller to perform operations that include outputting the first drive signal when th_{T}>T_{D}

B6. In accordance with any torque tool set forth and described herein, the instructions of computer-executable program code, which when executed by one or more processors of the controller, causes the controller to perform operations that include outputting the second drive signal when th_{T}≤T_{D}.

B7. In accordance with any torque tool set forth and described herein, th_{T} is less than 50 NM.

B8. In accordance with any torque tool set forth and described herein, the instructions of computer-executable program code, which when executed by one or more processors of the controller, causes the controller to perform operations that include outputting the second drive signal a time period after a time when th_{T}≤T_{D}.

B9. In accordance with any torque tool set forth and described herein, the motor has a plurality of phase windings, each of which provides a respective voltage phase.

B10. In accordance with any torque tool set forth and described herein, the instructions of computer-executable program code, which when executed by one or more processors of the controller, causes the controller to perform operations that include outputting the second drive signal to cause disconnection of the plurality of phase windings and thereby output a zero drive current.

B111. In accordance with any torque tool set forth and described herein, the instructions of computer-executable program code, which when executed by one or more processors of the controller, causes the controller to perform operations that include outputting a third drive signal to cause shorting of the plurality of phase windings with one another.

B12. In accordance with any torque tool set forth and described herein, the instructions of computer-executable program code, which when executed by one or more processors of the controller, causes the controller to perform operations that include outputting the first drive signal as a drive current.

B13. In accordance with any torque tool set forth and described herein, the instructions of computer-executable program code, which when executed by one or more processors of the controller, causes the controller to perform operations that include outputting the second drive signal as a zero drive current.

B14. In accordance with any torque tool set forth and described herein, the instructions of computer-executable program code, which when executed by one or more processors of the controller, causes the controller to perform operations that include outputting the first drive signal a predetermined time period after outputting the second drive signal.

B115. In accordance with any torque tool set forth and described herein, the torque detector comprises a strain gauge transducer.

B116. In accordance with any torque tool set forth and described herein, a user interface is provided and operable to facilitate a user to set the threshold torque value (th_{T}) as an input value and also change the threshold torque value (th_{T}).

B17. In accordance with any torque tool set forth and described herein, the motor is additionally operable to operate in a third rotation mode so as to not rotate the engaging mechanism and thereby cause the engaging mechanism to transfer a third torque to the fastening element.

B18. In accordance with any torque tool set forth and described herein, the instructions of computer-executable program code, which when executed by one or more processors of the controller, causes the controller to perform operations that include outputting, when th_{T}=T_{D}, a third drive signal after outputting the second drive signal.

B19. In accordance with any torque tool set forth and described herein, the instructions of computer-executable program code, which when executed by one or more processors of the controller, causes the controller to perform operations that include calculating an average torque value (T_{AV}).

B20. In accordance with any torque tool set forth and described herein, the instructions of computer-executable program code, which when executed by one or more processors of the controller, causes the controller to perform operations that include calculating, after outputting a third drive signal and based on T_{AV}, a time (t) to output the first drive signal such that T_{AV} is less than or equal to a threshold average torque value, th_{TA}.

### Clause C

A computer-implemented method of operating a torque tool having a motor and an engagement mechanism, the computer-implemented method including one or more of the following: controlling the motor to operate between a plurality of operating modes that include a first rotation mode and a second rotation mode that rotates the engaging mechanism; detecting a magnitude of torque (T_{D}) applied to a fastening element; outputting a torque signal based on T_{D}; outputting a first drive signal to cause the motor to operate in the first rotation mode; and outputting a second drive signal to cause the motor to operate in the second rotation mode based on the torque signal.

### Subclauses C1-C19

C1. In accordance with any computer-implemented method set forth and described herein, in the first rotation mode of the motor, the engaging mechanism is rotated at a first rate to transfer a first torque to the fastening element.

C2. In accordance with any computer-implemented method set forth and described herein, in the second rotation mode of the motor, the engaging mechanism is rotated at a second rate to transfer a second torque to the fastening element.

C3. In accordance with any computer-implemented method set forth and described herein, further including storing a threshold torque value (th_{T}) in the non-transitory memory.

C4. In accordance with any computer-implemented method set forth and described herein, further including comparing the magnitude of torque based on the torque signal to th_{T}.

C5. In accordance with any computer-implemented method set forth and described herein, further including outputting the first drive signal when th_{T}>T_{D}.

C6. In accordance with any computer-implemented method set forth and described herein, further including outputting the second drive signal when th_{T}≤T_{D}.

C7. In accordance with any computer-implemented method set forth and described herein, th_{T} is less than 50 NM.

C8. In accordance with any computer-implemented method set forth and described herein, further including outputting the second drive signal a time period after a time when th_{T}≤T_{D}.

C9. In accordance with any computer-implemented method set forth and described herein, the motor has a plurality of phase windings, each of which provides a respective voltage phase.

C10. In accordance with any computer-implemented method set forth and described herein, further including outputting the second drive signal to cause disconnection of the plurality of phase windings and thereby output a zero drive current.

C11. In accordance with any computer-implemented method set forth and described herein, further including outputting a third drive signal to cause shorting of the plurality of phase windings with one another.

C12. In accordance with any computer-implemented method set forth and described herein, further including outputting the first drive signal as a drive current.

C13. In accordance with any computer-implemented method set forth and described herein, further including outputting the second drive signal as a zero drive current.

C14. In accordance with any computer-implemented method set forth and described herein, further including outputting the first drive signal a predetermined time period after outputting the second drive signal.

C15. In accordance with any computer-implemented method set forth and described herein, further including operating the motor in a third rotation mode so as to not rotate the engaging mechanism.

C16. In accordance with any computer-implemented method set forth and described herein, in the third rotation mode of the motor, the engaging mechanism is caused to transfer a third torque to the fastening element.

C17. In accordance with any computer-implemented method set forth and described herein, further including outputting, when th_{T}=T_{D}, a third drive signal after outputting the second drive signal.

C18. In accordance with any computer-implemented method set forth and described herein, further including calculating an average torque value (T_{AV}).

C19. In accordance with any computer-implemented method set forth and described herein, further including calculating, after outputting a third drive signal and based on T_{AV}, a time (t) to output the first drive signal such that T_{AV} is less than or equal to a threshold average toque value, th_{TA}.

What is claimed is:

1. A reaction force mitigation (RFM) system for a torque tool having an engaging mechanism and a motor, the RFM system comprising:
a torque detector operable to detect a magnitude of torque (T_{D}) applied to a fastening element by the torque tool and output a torque signal based on the detected T_{D}; and
a controller having one or more processors and a non-transitory memory having instructions of computer-executable program code, which when executed by the one or more processors of the controller, causes the controller to perform operations that include outputting:
a first drive signal to cause the motor to operate in a first rotation mode to cause the engaging mechanism to rotate at a first rate that transfers a first torque to the fastening element, and
a second drive signal, based on the torque signal, to cause the motor to operate in a second rotation mode to cause the engaging mechanism to rotate at a second rate that transfers a second torque to the fastening element.

2. The RFM system of claim 1, wherein the instructions of computer-executable program code, which when executed by the one or more processors of the controller, cause the controller to perform operations that further include:
storing a threshold torque value (th_{T}) in the non-transitory memory,
comparing the magnitude of torque based on the torque signal to th_{T},
outputting the first drive signal when th_{T}>T_{D}, and
outputting the second drive signal when th_{T}≤T_{D}.

3. The RFM system of claim 2, wherein the instructions of computer-executable program code, which when executed by one or more processors of the controller, causes the controller to perform operations that further include outputting the second drive signal a time period after a time when th_{T}≤T_{D}.

4. The RFM system of claim 1, wherein the instructions of computer-executable program code, which when executed by the one or more processors of the controller, cause the controller to perform operations that further include outputting a third drive signal to cause the motor to operate in a third rotation mode to cause the engaging mechanism to not rotate and thereby cause the engaging mechanism to transfer a third torque to the fastening element.

5. The RFM system of claim 4, wherein the instructions of computer-executable program code, which when executed by the one or more processors of the controller, cause the controller to perform operations that further include outputting, when th_{T}=T_{D}, the third drive signal after outputting the second drive signal.

6. The RFM system of claim 5, wherein the instructions of computer-executable program code, which when executed by the one or more processors of the controller, cause the controller to perform operations that further include calculating an average torque value (T_{AV}).

7. The RFM system of claim 6, wherein the instructions of computer-executable program code, which when executed by the one or more processors of the controller, cause the controller to perform operations that further include calculating, after outputting the third drive signal and based on T_{AV}, a time (t) to output the first drive signal such that T_{AV}≤th_{TA}.

8. A torque tool, comprising:
an engaging mechanism operable to engage a fastening element; and
a motor that is operable in a plurality of operating modes that include a first rotation mode to rotate the engaging mechanism at a first rate to transfer a first torque to the fastening element, and a second rotation mode to rotate the engaging mechanism at a second rate to transfer a second torque to the fastening element;
a torque detector operable to detect a magnitude of torque (T_{D}) applied to the fastening element and to output a torque signal based on the detected T_{D}; and
a controller having one or more processors and a non-transitory memory having instructions of computer-executable program code, which when executed by the one or more processors of the controller, causes the controller to perform operations that include outputting:
a first drive signal to cause the motor to operate in the first rotation mode, and
a second drive signal to cause the motor to operate in the second rotation mode based on the torque signal.

9. The torque tool of claim 8, wherein the instructions of computer-executable program code, which when executed by the one or more processors of the controller, cause the controller to perform operations that further include:
storing a threshold torque value (th_{T}) in the non-transitory memory,
comparing the magnitude of torque based on the torque signal to th_{T},
outputting the first drive signal when th_{T}>T_{D}, and
outputting the second drive signal when th_{T}≤T_{D}.

10. The torque tool of claim 9, wherein the instructions of computer-executable program code, which when executed by one or more processors of the controller, causes the controller to perform operations that further include outputting the second drive signal a time period after a time when th_{T}≤T_{D}.

11. The torque tool of claim 8, wherein the instructions of computer-executable program code, which when executed by the one or more processors of the controller, cause the controller to perform operations that further include outputting a third drive signal to cause the motor to operate in a third rotation mode to cause the engaging mechanism to not rotate and thereby cause the engaging mechanism to transfer a third torque to the fastening element.

12. The torque tool of claim 11, wherein the instructions of computer-executable program code, which when executed by the one or more processors of the controller, cause the controller to perform operations that further include outputting, when th_{T}=T_{D}, the third drive signal after outputting the second drive signal.

13. The torque tool of claim 12, wherein the instructions of computer-executable program code, which when executed by the one or more processors of the controller, cause the controller to perform operations that further include calculating an average torque value (T_{AV}).

14. The torque tool of claim 13, wherein the instructions of computer-executable program code, which when executed by the one or more processors of the controller, cause the controller to perform operations that further include calculating, after outputting the third drive signal and based on T_{AV}, a time (t) to output the first drive signal such that T_{AV}≤th_{TA}.

15. A computer-implemented method of operating a torque tool having a motor and an engagement mechanism, the computer-implemented method comprising:
controlling the motor to operate between a plurality of operating modes that include a first rotation mode and a second rotation mode that rotates the engaging mechanism;
detecting a magnitude of torque (T_{D}) applied to the fastening element;
outputting a torque signal based on T_{D};
outputting a first drive signal to cause the motor to operate in the first rotation mode that rotates the engaging mechanism at a first rate to transfer a first torque to the fastening element; and
outputting, based on the torque signal, a second drive signal to cause the motor to operate in the second rotation mode that rotates the engaging mechanism at a second rate to transfer a second torque to the fastening element.

16. The computer-implemented method of claim 15, further comprising:
storing a threshold torque value (th_{T}) in the non-transitory memory,
comparing the magnitude of torque based on the torque signal to th_{T},
outputting the first drive signal when th_{T}>T_{D}, and
outputting the second drive signal when th_{T}≤T_{D}.

17. The computer-implemented method of claim 16, wherein the second drive signal is output a time period after a time when th_{T}≤T_{D}.

18. The computer-implemented method of claim 17, further comprising outputting a third drive signal to cause the motor to operate in a third rotation mode that does not rotate the engaging mechanism and thereby cause the engaging mechanism to transfer a third torque to the fastening element.

19. The computer-implemented method of claim 18, wherein when th_{T}=T_{D}, the third drive signal is output after the second drive signal is output.

20. The torque tool of claim 19, further comprising:
calculating an average torque value (T_{AV}), and
calculating, after outputting the third drive signal and based on T_{AV}, a time (t) to output the first drive signal such that T_{AV}≤th_{TA}.
